(19) United States
(12) Patent Application Publication
(10) Pub. No.: US 2020/0400973 A1
(43) Pub. Date: Dec. 24, 2020

(54) LENS COMPRISING AN ADJUSTABLE FOCAL LENGTH

(71) Applicant: OPTOTUNE AG, Dietikon (CH)

(72) Inventors: Alexandre LARMAGNAC, Widen (CH); Joerg ALBUSCHIES, Zürich (CH); Anja STOBBE-KREEMERS, Mollis (CH); Manuel ASCHWANDEN, Allenwinden (CH)

(73) Assignee: OPTOTUNE AG, Dietikon (CH)

(21) Appl. No.: 16/956,621

(22) PCT Filed: Dec. 21, 2018
(86) PCT No.: PCT/EP2018/086804

§ 371 Date: Jun. 22, 2020

(30) Foreign Application Priority Data
Dec. 22, 2017 (EP) 17210503.3

(51) Int. Cl. G02C 7/04; G02C 7/08

(52) U.S. Cl. CPC G02C 7/041; G02C 7/085; G02C 7/083; G02C 7/049

(57) ABSTRACT

The invention relates to a lens (1) for vision correction, particularly in form of a contact lens, for vision correction, wherein the lens (1) comprises: a transparent base element (10) having a back side (12), and a front side (11) facing away from the back side (12), a transparent and elastically expandable membrane (20) connected to said base element (10), wherein said membrane (20) comprises a back side (22) that faces said front side (11) of the base element (10), a lens shaping member (particularly (30) connected to said the membrane (20)) so that the lens shaping member (30) defines an area (23) of the membrane (20) having an adjustable curvature, and wherein the lens (1) comprises a lens volume (41) adjacent said area (23), and wherein the lens (1) comprises a reservoir volume (42) arranged in a peripheral region (24) of the lens (1), wherein a transparent liquid (50) is arranged in the lens volume and in the reservoir volume, and at least one electro-osmotic pump (70) configured to transfer transparent liquid (50) from the reservoir volume (42) to the lens volume (41) or vice versa such that the curvature of said area (23) of the membrane (20) changes and therewith the focal length of the lens (1).

The present invention relates to a lens, particularly a contact lens having an adjustable focal length.

More particularly, the present invention relates to designs and methods of how to use and control such fluidic lenses. The present invention is not only applicable to contact lenses but also to other lenses that may be used in a variety of different applications.

In WO2008115251 a soft contact lens is described that has a body with a central zone aligned with the optical axis of the eye when a user wears the lens. In one embodiment the soft lens includes a chamber that extends from a lower portion of the lens to its central axis and is arranged such that when a person looks down, a fluid is squeezed from the reservoir and changes the optical characteristics of the lens.

Further, WO98/14820 describes a variable focus contact lens, which has a body with a first half and an opposite second half. The body also has a first peripheral surface, an opposite second peripheral surface and an associated focal length. The lens includes a first material that is resilient so that when a compressive force is applied to the first surface and the second surface, the focal length of the lens changes in proportion to the compressive force. A force-distributing structure is disposed for distributing forces within the lens so as to inhibit astigmatism in the lens.

Furthermore, the fluid-filled adjustable contact lens of US 2012/0268712 shows an exemplary contact lens which includes a lens chamber configured to be positioned on a pupil of a user wearing the contact lens; a reservoir fluidly connected to the lens chamber, an actuator configured to transfer fluid back and forth between the lens chamber and the reservoir; a sensor configured to sense movement from the user and transmit a control signal when a predetermined movement is performed by the user, and a processor configured to actuate the actuator upon receipt of the control signal from the sensor.

Further, U.S. Pat. No. 8,755,124 describes an adjustable optical lens comprising a membrane, a support for the membrane, a fluid between the membrane and the support, an actuator for deforming the membrane, and a rigid ring connected to the membrane surrounded by the rigid ring where the rigid ring has a defined circumference.

Based on the above, the problem underlying the present invention is to provide an improved contact lens that particularly allows to precisely adjust the focal length of the contact lens, and that can be operated at low voltage levels and can further resist mechanical deformations of the lens (caused for instance by the eyelid).

This problem is solved by a lens (e.g. contact lens) having the features of claim 1. Preferred embodiments of the present invention are stated in the corresponding sub claims or are described below.

According to claim 1, a lens for vision correction, particularly a contact lens, is disclosed, wherein the lens is particularly configured to be placed directly on the surface of an eye of a person, wherein the lens further comprises:
a transparent base element having a back side, and a front side facing away from the back side,
a transparent and elastically expandable membrane connected to said base element, wherein said membrane comprises a back side that faces said front side of the base element,
a lens shaping member (particularly connected to said the membrane) so that the lens shaping member defines an area of the membrane having an adjustable curvature (wherein particularly said area has a circular boundary), and
wherein the lens comprises a lens volume adjacent said area (and particularly arranged between the base element and said area), and wherein the lens comprises a reservoir volume arranged in a peripheral region of the lens, wherein a transparent liquid is arranged in the lens volume and in the reservoir volume, and
at least one electro-osmotic pump configured to transfer transparent liquid from the reservoir volume to the lens volume or vice versa such that the curvature of said area of the membrane changes and therewith the focal length of the lens.

Particularly, using an electro-osmotic pump as an actuating device has several advantages, such as that it can be operated at low voltage levels, can resist mechanical deformations of the lens that may be caused for instance by an eyelid of a user/person wearing the lens. Furthermore, due to the fact, that an electro-osmotic pump is used, the lens does not need to comprise any moving parts, which makes it compact and robust.

Particularly, the base element is formed in one piece. Alternatively, the base element may also comprise several separate parts bonded to one another.

According to an embodiment of the contact lens according to the invention, the base element is configured to be placed directly on the surface of an eye of a person or user such that the back side of the base element contacts the eye. Thus, the incident light first passes through the membrane (i.e. through the curvature-adjustable area), then through the lens volume and finally through the base element before entering the eye on which it is placed.

In an alternative embodiment it is also possible that a front side of the membrane faces the eye of a person/user using the lens (with the front side of the membrane facing away from the back side of the membrane). Here, the incident light first passes through the base element then passes through the lens volume and finally through the membrane (i.e. through the curvature-adjustable area) before entering the eye in front of which it is placed.

In an embodiment of the present invention, the lens shaping member may be integrally formed with the membrane or the base element and may protrude from said back side of the membrane or the front side of the base element.

Further, in an embodiment of the present invention, said area of the membrane is configured for passing light through the area which deflects the light passing through it according to the current curvature of said area of the membrane. Particularly, said area corresponds to the clear aperture of the lens (contact lens) according to the invention.

Further, in an embodiment of the present invention, the base element may form a base lens. Furthermore, in an embodiment of the present invention, the base element is stiffer than the membrane. Likewise, the lens shaping member is preferably stiffer than the membrane so as to be able to define the shape of the lens (i.e. of said area having an adjustable curvature).

Furthermore, according to an embodiment of the lens according to the present invention, the back side of the base element comprises a concave curvature so that the back side of the base element can fully contact the eye of a person.

Particularly, the base element can consist of or comprise one of the following materials:
a glass,
polymers including elastomers (e.g. thermoplastic elastomers, liquid crystal elastomers, silicones such as PDMS, acrylics, urethanes),
a plastic including thermoplasts (e.g. ABS, PA, PC, PMMA, PET, PE, PP, PS, PVC) and duroplasts,
a gel (e.g. silicone hydrogel, polymacon or optical gel OG-1001 by Liteway).

Particularly, the transparent and elastically deformable membrane can consist of or comprise one of the following materials:
a glass,
a polymer including elastomers (e.g. TPE, LCE, silicones such as PDMS, acrylics, urethanes),
a plastic including thermoplasts (e.g. ABS, PA, PC, PMMA, PET, PE, PP, PS, PVC) and duroplasts.
a gel (e.g. silicone hydrogel, polymacon or optical gel OG-1001 by Liteway),

Further, according to an embodiment of the lens according to the present invention, the at least one electro-osmotic pump comprises a membrane assembly, the membrane assembly comprising a porous membrane, a first electrode, and a second electrode, wherein the porous membrane is arranged between said electrodes, and/or wherein said electrodes are connected to the porous membrane. Particularly, the first and the second electrode are also porous.

Particularly, according to an embodiment, the porous membrane comprises a first surface and a second surface, wherein said two surfaces face away from each other. Further, according to an embodiment, the first electrode is joined to the first surface of the membrane so that the first electrode covers the entire first surface. Further, according to an embodiment, the second electrode is joined to second surface of the membrane so that the second electrode covers the entire second surface. Particularly, a gap (e.g. due to a glue) between the first surface and the first electrode and/or a gap (e.g. due to a glue) between the second electrode and the second surface is less than 100 μm thick.

Further, according to an embodiment of the lens according to the present invention, said membrane assembly separates a first region of the reservoir volume from a second region of the reservoir volume.

Particularly, according to an embodiment, the membrane assembly is constructed such that any transport of liquid from the first region of the reservoir volume to the second region of the reservoir volume is only possible through the membrane assembly. Particularly, the membrane assembly itself as well as bonding areas to the base element and/or to the transparent membrane of the lens do not comprise any openings or defects through which liquid can pass in an uncontrolled way.

According to an embodiment, said regions of the reservoir volume are arranged on top of one another, wherein the first (e.g. upper) region is arranged between said transparent and elastically deformable membrane (or elastically deformable wall, see below) and said membrane assembly, and wherein particularly said second (e.g. lower) region is arranged between the membrane assembly and the front (or back) side of the base element. Alternatively, the second (e.g. upper) region is arranged between said transparent and elastically deformable membrane (or elastically deformable wall, see below) and said membrane assembly, and wherein particularly said first (e.g. lower) region is arranged between the membrane assembly and the front (or back) side of the base element.

Furthermore, the first and the second region of the reservoir volume can also be arranged side by side along the front side of the base element (see also below)

Further, according to an embodiment of the lens according to the present invention, the lens volume and the first and the second region of the reservoir volume are filled with said transparent liquid, wherein particularly the porous membrane or membrane assembly is in flow connection with the lens volume via the second region of the reservoir volume, and wherein in order to transfer said liquid from the reservoir volume to the lens volume, the at least one electro-osmotic pump is configured to pump liquid from the first region of the reservoir volume into the second region of the reservoir volume. Further, according to an embodiment, in order to transfer said liquid from the lens volume to the reservoir volume, the at least one electro-osmotic pump is configured to pump liquid from the second region of the reservoir volume into the first region of the reservoir volume.

Further, according to an alternative embodiment of the lens according to the present invention, the lens comprises an actuator membrane which separates the reservoir volume from a pump volume, wherein the membrane assembly separates the pump volume into a first region and a second region, wherein the second region of the pump volume is arranged between the membrane assembly (or porous membrane) and the actuator membrane.

Further, according to an embodiment, said regions of the pump volume can be arranged on top of one another, wherein the first (e.g. upper) region is arranged between said transparent and elastically deformable membrane (or elastically deformable wall, see below) and said membrane assembly (or porous membrane), and wherein particularly said second (e.g. lower) region of the pump volume is arranged between the membrane assembly (or porous membrane) and the reservoir volume, and wherein the reservoir volume is arranged between the actuator membrane and the front (or back) side of the base element. Alternatively, the second (e.g. upper) region of the pump volume is arranged between said transparent and elastically deformable membrane (or elastically deformable wall, see below) and said membrane assembly (or porous membrane), and wherein particularly said first (e.g. lower) region of the pump volume is arranged between the membrane assembly (or porous membrane) and the front (or back) side of the base element.

Alternatively, the first and the second region of the pump volume can also be arranged side by side along the front side of the base element.

Further, according to an embodiment of the lens according to the present invention, the lens volume and the reservoir volume are filled with said transparent liquid, wherein the first region and the second region of the pump volume are filled with a (e.g. transparent) pumping liquid. Particularly, using two different liquids, i.e. a transparent liquid in the lens volume and a different pumping liquid allows to choose a certain liquid for the lens volume that is optimized regarding its optical properties while the pumping liquid can be chosen for better pumping performance (e.g. optimal viscosity and stability)

Particularly, in an embodiment, the pumping liquid can be identical to said liquid arranged in the lens volume and in the reservoir volume. Alternatively the pumping liquid can also be different from said liquid arranged in the lens volume and in the reservoir volume. Here the pumping liquid merely is a working fluid that can be optimized regarding its interaction with the electro-osmotic pump, while the transparent liquid can be optimized regarding its optical properties.

Further, according to an embodiment of the lens according to the present invention, in order to transfer said liquid from the reservoir volume to the lens volume, the at least one electro-osmotic pump is configured to pump pumping liquid from the first region of the pump volume into the second region of the pump volume, so as to press pumping liquid against the actuator membrane such that the actuator membrane pushes liquid residing in the adjacent reservoir volume into the lens volume (here, the actuator membrane serves as a piston that separates the pumping liquid from the liquid so that the two liquids cannot mix. Further, in an embodiment, in order to transfer liquid from the lens volume to the reservoir volume, the at least one electro-osmotic pump is configured to pump pumping liquid from the second region of the pump volume into the first region of the pump volume so that the actuator membrane draws liquid out of the lens volume into the adjacent reservoir volume.

Further, according to an embodiment of the lens according to the present invention, the lens comprises an inner annular structure and an outer annular structure, wherein the membrane assembly (particularly the porous membrane and said electrodes) is connected to the outer and the inner annular structure, wherein particularly, said membrane assembly and said annular structures form a sub-assembly of the lens.

Particularly, according to an embodiment, the membrane assembly comprises an inner edge connected to the inner annular structure and an outer edge connected to the outer annular structure.

Further, according to an embodiment of the lens according to the present invention, the base element comprises a step particularly a circumferential step extending along a periphery of the base element for aligning the membrane assembly with respect to the base element.

Further, according to an embodiment of the lens according to the present invention, the circumferential step is configured for aligning the outer annular structure connected to the membrane assembly with respect to the base element, wherein particularly the outer annular structure is arranged on the step (or contacts the step) in a form-fitting fashion.

Further, according to an embodiment of the lens according to the present invention, the lens shaping member is formed by the inner annular structure. Particularly, the lens shaping member can be a part of the inner annular structure and/or can be integrated into the inner annular structure.

Further, according to an embodiment of the lens according to the present invention, the lens shaping member (or inner annular structure) can be formed out of or comprises a material such as: a metal, silicon, a plastic material such as polyimide, PET, or an elastomer like PDMS.

Further, according to an embodiment of the lens according to the present invention, the inner annular structure is bonded to the front side of the base element and to the back side of the membrane so that said area of the membrane is e.g. defined by an inner circular edge of the inner annular structure (or lens shaping member).

Further, according to an embodiment of the lens according to the present invention, the outer and/or inner annular structure forms a sealing member, respectively, that is particularly configured to prevent liquid from going around the membrane assembly, wherein the outer annular structure is bonded to the front side of the base element.

Further, according to an embodiment of the lens according to the present invention, the first region of the reservoir volume or of the pump volume is at least partially delimited by an elastically deformable wall which can be e.g. a portion of said transparent and elastically deformable membrane comprising said area.

Further, according to an embodiment of the lens according to the present invention, the reservoir volume or the second region of the reservoir volume is connected to the lens volume via at least one channel or via a plurality of channels.

Further, according to an embodiment of the lens according to the present invention, the membrane assembly comprises one of: a curved shape, an annular shape, or forms a spherical segment, or a conical frustum.

Further, according to an embodiment of the lens according to the present invention, the membrane assembly extends along the front side of the base element so that the membrane assembly comprises a first side and a second side facing away from the first side of the membrane assembly, wherein the first side of the membrane assembly faces away from the front side of the base element, and wherein the second side of the membrane assembly faces the front side of the base element. Here, the membrane assembly (or the porous membrane) can be formed e.g. as a spherical segment or as conical frustum. However, other shapes are also possible.

Further, according to an embodiment of the lens according to the present invention, the membrane assembly comprises an undulated shape.

Further, according to an embodiment of the lens according to the present invention, the membrane assembly comprises an undulated shape in a direction pointing from a center of the lens volume towards a periphery of the lens. Here, particularly, the membrane assembly can comprise circumferential maxima and minima that alternate in said directions pointing from a center of the lens volume towards the periphery of the lens, respectively.

Alternatively, the membrane assembly may comprise an undulated shape in a peripheral direction of the lens, so that the maxima and minima alternate in said peripheral direction.

Further, according to an embodiment of the lens according to the present invention, the membrane assembly comprises a curved portion (e.g. a crease, particularly a circumferential crease) such that the membrane assembly comprises a first section and a second section connected via the curved portion (or crease) and facing each other, wherein each of said sections of the membrane assembly extends along the front side of the base element. Particularly, the first section of the membrane assembly extends between the base element and the second section of the membrane assembly.

Further, according to an embodiment of the lens according to the present invention, the membrane assembly comprises a plurality of curved portions, wherein each curved portion connects two adjacent sections of the membrane assembly to one another such that the membrane assembly comprises a plurality of sections arranged on top of one another in a direction normal to the front side of the base element or in a direction parallel to the optical axis of the lens.

Further, according to an embodiment of the lens according to the present invention, the at least one electro-osmotic membrane is configured to generate a flow of the liquid that is directed towards the front side of the base element or away from the front side of the base element.

Further, according to an embodiment of the lens according to the present invention, the membrane assembly extends along a direction normal to the front side of the base element or along a direction parallel to the optical axis of the lens, such that the membrane assembly comprises a first side facing away from the optical axis of the lens and a second side facing said optical axis, wherein the first side of the membrane assembly particularly faces away from the second side of the membrane assembly.

Further, according to an embodiment of the lens according to the present invention, the membrane assembly forms a spiral extending e.g. in a peripheral direction of the lens around an optical axis of the lens, wherein particularly a gap between an end section of an outermost turn of the spiral and an adjacent turn of the spiral arranged further inside is sealed with a seal to prevent passage of liquid through said gap.

Further, according to an embodiment of the lens according to the present invention, the membrane assembly further comprises a first and a second porous layer, wherein the porous membrane and the two electrodes are arranged between the two porous layers, and wherein particularly the first porous layers is connected to the first electrode and the second porous layer is connected to the second electrode.

Further, according to an embodiment of the lens according to the present invention, each of said electrodes of the membrane assembly of the at least one electro-osmotic pump comprises at least one elongated conductor, particularly two elongated conductors. Particularly, the respective conductor is arranged along an edge of the respective electrode. Particularly, said elongated conductors are intended to ensure that a voltage drop (and hence field strength applied) over the membrane assembly is limited. Particularly, the respective elongated conductor comprises a highly conductive material such as gold (Au), silver (Ag), platinum (Pt), copper (Cu), or another material with low sheet resistance.

Further, particularly, the electrodes of the electro-osmotic pump preferably have a very low ohmic resistance to prevent a voltage drop over a very long spiral. Particularly, said gold (or other material) conductors can be added to ensure such a low ohmic resistance.

Furthermore, according to an embodiment, the respective electrode of the membrane assembly of the at least one electro-osmotic pump does not form a closed loop (in which current can be induced inductively). This would allow using induction for wireless power transfer to the lens.

Further, according to an embodiment of the lens according to the present invention, the membrane assembly is folded onto itself to form a folded structure such that two sections of the second porous layer contact each other and extend side by side, wherein said two sections form the innermost layers of the folded structure, and wherein said folded structure is formed into said spiral. Furthermore, in an embodiment, a crease of the folded structure forms an end of an innermost turn of the spiral.

Further, according to an embodiment of the lens according to the present invention, the spiral or folded structure comprises a plurality of turns.

Further, according to an embodiment of the lens according to the present invention, the spiral or folded structure comprises more than ten turns.

Further, according to an embodiment of the lens according to the present invention, an end section of an outermost turn of the folded structure comprises an inner portion and an outer portion of the porous membrane, which inner and outer portion are separated by said two sections of the first porous layer, wherein said inner portion is connected via a liquid-tight seal to a neighboring portion of the porous membrane of an adjacent turn of the spiral, which adjacent turn is arranged further inside (with respect to the outermost turn of the spiral/folded structure).

This allows to prevent passage of liquid through a flow path between said inner portion of the porous membrane and said neighboring portion of the porous membrane.

Further, according to an embodiment of the lens according to the present invention, the membrane assembly is arranged in the reservoir volume.

Further, according to an embodiment of the lens according to the present invention, the membrane assembly extends from an [circumferential] outer region (41a) of the reservoir volume (41) [in a spiraling fashion] towards the lens shaping member (30).

Further, according to an embodiment of the lens according to the present invention, the lens shaping member separates the reservoir volume from the lens volume.

Further, according to an embodiment of the lens according to the present invention, the membrane assembly is one of:
arranged below the lens shaping member (e.g. between the base element and lens shaping member)
forms a part of the lens shaping member;
forms the lens shaping member.

Further, according to an embodiment of the lens according to the present invention, in order to transfer said liquid from the reservoir volume to the lens volume, the at least one electro-osmotic pump is configured to pump liquid through the membrane assembly into the lens volume. Further, in an embodiment, in order to transfer said liquid from the lens volume to the reservoir volume, the at least one electro-osmotic pump is configured to pump liquid through the membrane assembly from the lens volume into the reservoir volume.

Further, according to an embodiment of the lens according to the present invention, the membrane assembly covers less than 10% of the front side of the base element. Particularly in case of a spiral design of the membrane assembly, the latter is invisible in case said it covers less than 10% of the front side of the base element.

Further, according to an embodiment of the lens according to the present invention, the at least one electro-osmotic membrane is configured to generate a flow of the liquid that is directed along the front side of the base element and particularly perpendicular to said first or second side of the membrane.

Further, according to an embodiment of the lens according to the present invention, the reservoir volume is at least partially delimited by an elastically deformable wall.

Particularly, according to an embodiment of the lens according to the present invention, said elastically deformable wall is formed by a portion of said transparent and elastically expandable membrane.

Further, according to an embodiment of the lens according to the present invention, the reservoir volume is connected to the lens volume via at least one channel or via a plurality of channels.

Further, according to an embodiment, the at least one channel or said plurality of channels is at least one of:
at least partially formed into the lens shaping member and/or into the base element;
formed into the lens shaping member;
arranged between a portion of the lens shaping member and a portion of the base element.

Further, according to an embodiment of the lens according to the present invention, the at least one channel comprises a cross-section area in the range from 0.01 mm² to 0.15 mm², wherein particularly said cross-section area amounts to 0.05 mm² to 0.1 mm². Further, according to an embodiment, the at least one channel comprises a length (e.g. in a direction perpendicular to said cross-section area) in the range from 0.25 mm and 0.75 mm.

Further, according to an embodiment of the lens according to the present invention, said plurality of channels are arranged along the lens shaping member (or inner annular structure) or along a region of the lens between the lens volume and the reservoir volume, wherein particularly the channels can be equidistantly spaced (e.g. can be evenly distributed along the lens shaping member/inner annular structure), so as to prevent a deflection of a portion of the lens shaping member arranged above said channels (e.g. between the membrane and the channels).

Particularly, the channel(s) should be dimensioned such that for a given liquid viscosity enough liquid can be transferred to the lens in the desired time. Particularly, in the case of a lens filled with water, the cross-section area of the channel and the length of the channel is given by the above stated ranges. Particularly, the cross-section area can be 0.1 mm² and the length of the channel can be 0.5 mm according to an example of the present invention.

Since the lens shaping member portion above the at least one channel is not supported, it can deflect if there is a pressure difference between the lens volume and the outside of the lens. The support structure can be added in the at least one channel to prevent or reduce the lens shaping member's shaper deflection. Particularly, said deflection can be reduced by decreasing the channel width and increasing the amount of channels to keep the same resistance to flow. Hence, when a 50 μm membrane is bonded on a lens shaping member of the same material, height of 50 μm to 100 μm and width of 0.5 mm to 1 mm, a channel width of 1 mm can be too large and may have a negative impact on image quality. It is then preferred to have e.g. four channels with a width of e.g. 250 μm to keep a good image quality. Further, reducing the width of the channel may induce filling issues during the fabrication process as the liquid (e.g. water) may not flow from the periphery (e.g. reservoir volume) towards the center (e.g. lens volume) without sufficient pressure due to poor wetting of the surfaces of the base element, lens shaping member, and membrane (e.g. silicone). This problem may be overcome by treating said surfaces, for example using plasma activation to increase wettability or by first filling the lens with an alcohol like isopropanol and then replacing the isopropanol with said liquid (e.g. water).

According to an embodiment, the lens shaping member is integrated into the transparent and elastically expandable membrane. In this case, according to an embodiment, at least a portion of the at least one channel (or portions of said plurality of channels) can be formed in the lens shaping member or can be arranged underneath the lens shaping member.

Furthermore, according to an embodiment, the membrane integrated lens shaping member is configured to support the transparent and elastically expandable membrane in the area of the at least one channel or of said plurality of channels (which is beneficial in contrast to a thin, unstructured membrane being assembled on a base element with a ring).

Further, according to an embodiment of the lens according to the present invention, the lens shaping member is an annular lens shaping member (particularly comprising a circular edge for defining said area of the membrane).

Further, according to an embodiment of the lens according to the present invention, the at least one electro-osmotic pump is configured to pump said liquid so as to transfer liquid from the reservoir volume to the lens volume or vice versa depending on a voltage applied to said electrodes.

Further, according to an embodiment of the lens according to the present invention, the lens comprises an energy source (e.g. a battery, particularly a rechargeable battery, or a capacitor) for providing said voltage that is applied between the first and the second electrode of the at least one electro-osmotic pump.

Further, according to an embodiment of the lens according to the present invention, said first electro-osmotic pump comprises a first contact lead for connecting an energy source (e.g. a battery) to the first electrode, and a second contact lead for connecting said energy source to the second electrode, wherein particularly said first contact lead is arranged at a first end of the first electro-osmotic pump, and wherein particularly said second contact lead is arranged at an opposite second end of the first electro-osmotic pump. Other configurations are also conceivable.

Further, according to an embodiment of the lens according to the present invention, the energy source can be arranged in the reservoir volume or outside the reservoir volume.

Further, according to an embodiment of the lens according to the present invention, the lens comprises a charging device (also denoted as energy harvester) configured for providing electrical energy to the energy source.

Further, according to an embodiment of the lens according to the present invention, the charging device can comprise an inductive coil (see also below) or a photodiode for charging the energy source (e.g. energy storage such as a battery or capacitor, see above).

Further, according to an embodiment of the lens according to the present invention, the lens comprises a sensor configured to detect a state and/or movement of a user of the lens (i.e. a person wearing the lens), wherein particularly said movement is an eyelid movement of the user, or wherein particularly said state is a fully closed eyelid, or a partially closed eyelid of the user, wherein particularly said eyelid is an eyelid of an eye of the user, on which eye the lens is to be placed in particular, and wherein the sensor is configured to generate a corresponding control signal indicative of said state and/or movement.

Furthermore, according to an embodiment, the sensor can be a sensor that is configured to detect a distance to an object that a person wearing or using the lens is looking at. Particularly, the sensor can be a time-of-flight sensor.

Further, according to an embodiment of the lens according to the present invention, the lens comprises a processing unit configured to control said voltage.

Further, according to an embodiment of the lens according to the present invention, the processing unit is configured to control said voltage using said control signal. Particularly, a pumping speed (flow rate of the pumped liquid) increases with increasing voltage, which can be used to facilitate speed and control of the focal power.

Further, particularly, the energy source, charging device, processing unit, sensor or any other electronic components can be mounted to a designated area of the porous membrane of the at least one electro-osmotic membrane. The porous membrane provides a mechanical more stable substrate for mounting rigid components (compared to the more flexible and soft materials used to produce the base element and lens membrane). An additional advantage of such use of the porous membrane is that the oxygen permeability of the contact lens is maximized since no rigid, impermeable, circuit board materials have to be incorporated in the lens.

Particularly, the impedance of interconnects to the electrodes of the at least one electro-osmotic pump and the impedance of the electrode/liquid interface is preferably as low as possible to maximize a voltage drop over the porous membrane and thus maximize a pumping efficiency of the at least one electro-osmotic pump. Further, particularly, the electrode materials are preferably chosen such that undesired hydrolysis and other side reactions are minimized. Particularly, the electrode material and operating voltage level combination is preferably chosen such that decomposition of water is avoided or minimized (to minimize formation of gas bubbles in the lens or reservoir volumes) and particularly such that other electrochemical side reactions are also minimized.

Bubble formation is not desired since it can change the lens focal power in an undesired manner and decrease the electrode surface and may have a negative effect on proper pumping. However, bubble formation can be tolerated to a certain degree as the materials of the lens are particularly gas permeable and let bubbles escape over time allowing higher operation voltages over short times for a fast tuning of the focal length of the lens.

Further, particularly, the at least one electro-osmotic pump is pumping in a reverse direction when switching a polarity of said voltage applied to the electrodes of the membrane assembly. Preferably, the voltage is chosen such that the pump speed in both directions is similar, and the desired change in focal power can be reached in less than 1 second, preferably in less than 0.4 sec.

Particularly, in an embodiment, the processing unit is configured to control the energy source such that a voltage that is preferably below or equal to 1.2 V in an embodiment is applied for less than a second to the electrodes until a desired focal length of the lens is reached; higher voltages for shorter times are possible for faster tuning.

Further, according to an embodiment of the lens according to the present invention, the processing unit is configured to hold a desired focal length by causing (prompting) the energy source to apply voltage bursts of amplitude and rate to said electrodes of the membrane assembly that maintain a pressure of the liquid in the lens volume that corresponds to the desired focal length.

Further, according to an embodiment of the lens according to the present invention, the at least one electro-osmotic pump comprises a resting state (no voltage applied to the electrodes) in which the pressure of the liquid in the lens volume and in the reservoir volume is equal.

Further, according to an embodiment of the lens according to the present invention, the lens comprises at least one passive valve that is configured to reduce or block a back flow of liquid from the lens volume to the reservoir volume. The at least one passive valve can be configured to reduce or block said back flow through said at least one channel (several such passive valves can be employed in case a plurality of channels is used).

Further, according to an embodiment of the lens according to the present invention, the lens comprises at least one active valve that is configured to be opened so as to allow liquid to flow back from the lens volume into the reservoir volume for decreasing the focal length (or focal power) of the lens, or to allow liquid to flow from the reservoir into the lens volume for increasing the focal length of the lens. The at least one active valve can be configured to allow liquid to flow back from the lens volume into the reservoir volume (or into the lens volume from the reservoir volume) through said at least one channel (several such active valves can be employed in case a plurality of channels is used).

In this way one can greatly reduce power consumption when holding a desired focal power. Particularly, the aim here is to only consume power when tuning and almost no power when holding the tuned state of the lens.

Particularly, according to an embodiment, the lens is configured to close the at least one active valve to interrupt a flow connection between the reservoir volume and the lens volume, and wherein for increasing a flow rate of the liquid from the reservoir volume into the lens volume when the active valves is opened, the lens is configured to pressurize the reservoir volume when the active valve is closed.

Thus, when the lens needs to be tuned, the valve is opened and the pressurized liquid in the reservoir chamber is flowing into the optical zone (potentially at a higher flow rate as provided by the electro-osmotic pump itself).

The same would work in the opposite way, after closing the valve again, liquid from the second (e.g. bottom) portion of the reservoir volume could be pumped into the first portion of the reservoir volume, in this way creating an under-pressure, which then would again increase a flow rate of the liquid flow from the lens volume back into the reservoir volume when tuning down.

Therefore, according to an embodiment, the lens is configured to pump liquid from the second region of the reservoir volume to the first region of the reservoir volume when at least one active valve is closed to create an under-pressure in the second portion of the reservoir valve to increase a flow rate of the liquid from the lens volume to the reservoir volume when the at least one active valve is opened.

Further, according to an embodiment of the lens according to the present invention, at least one of the following components is mounted to the porous membrane: the sensor, the battery, the processing unit, the charging device.

Further, according to an embodiment of the lens according to the present invention, said components mounted on the porous membrane are interconnected by conductive tracks.

Further, according to an embodiment of the lens according to the present invention, said conductive tracks and/or said electrodes of the at least one electro-osmotic pump are printed on the porous membrane.

Further, according to an embodiment of the lens according to the present invention, the lens is configured to measure a pressure of the liquid in the lens volume (e.g. using a pressure sensor comprised by the lens).

Further, according to an embodiment of the lens according to the present invention, the lens (particularly the processing unit) is configured to determine from the measured pressure of the liquid in the lens volume a focal length (or focal power) of the lens. This is possible since a certain pressure is related to a certain deflection/curvature of said area of the transparent and elastically deformable membrane of the lens which in turn defines the focal power (or focal length) of the lens.

Further, according to an embodiment of the lens according to the present invention, the porous membrane can be a nanoporous membrane comprising nanochannels for the passage of liquid through the porous membrane, wherein for measuring said pressure in the lens volume the lens (particularly said processing unit) is configured to measure a streaming potential across the porous (particularly nanoporous) membrane using the electrodes of the membrane assembly (which streaming potential is generated by a pressure gradient across the pores, particularly nanochannels, of the porous membrane), and wherein the lens is configured to apply said voltage to the electrodes (particularly the processing unit is configured to cause the energy source to apply said voltage to the electrodes) for adjusting the focal length of the lens to a desired value, wherein the lens (e.g. the processing unit) is configured to repeatedly remove the voltage from the electrodes for a predefined time interval (e.g. in the range of 10 ms) allowing liquid to flow back from the reservoir volume into the lens volume, wherein the lens (particularly the processing unit) is configured to measure the streaming potential within the respective time interval, and wherein the lens (particularly the processing unit) is configured to compare the measured streaming potential to an expected value of the streaming potential corresponding to the desired focal length, wherein the lens (particularly the processing unit) is configured to adjust said voltage so that the respective measured streaming potential approaches the expected value of the streaming potential.

Further, according to an embodiment of the lens according to the present invention, the processing unit (controller) can be implemented in a microchip (the microchip may be mounted to the porous membrane, see above).

Further, according to an embodiment of the present invention, the membrane comprises a thickness that is smaller than 50 μm, particularly smaller than 30 μm, wherein particularly the thickness is below 20 μm.

Further, according to an embodiment of the present invention, the porous membrane is one of: a track etched substrate with cylindrical pores, a nanoporous substrate, particularly such that said liquid can flow through the substrate perpendicular to the plane of the substrate/porous membrane.

Further, according to an embodiment of the present invention, the porous membrane is made out of or comprises one of the following materials: polymer or elastomer, polycarbonate, polyethylene terephthalate (PET), DuPont's Nafion® (copolymer of tetrafluoroethylene and perfluorinated monomers containing sulfonic acid groups, e.g. CAS #66796-30-3), PDMS.

Further, according to an embodiment of the present invention, the porous membrane of the at least one electro-osmotic pump comprises pore walls that carry a zeta potential having an absolute value between 10 mV and 100 mV and/or comprise sulfonic (cation exchange) or aminic (anion exchange) groups and/or comprise ionic detergents such as SDS (sodium dodecyl sulfate) in the case of hydrophobic polymers and/or polyelectrolytes such as PSS (poly styrene sulfonate) and/or anionic or cationic molecules. Preferably, the zeta potential is as high as possible to increase the efficiency of the at least one electro-osmotic pump.

Further, according to an embodiment of the present invention, the porous membrane comprises pores having an inner surface that is coated or modified with the AE (anion exchange) or CE (cation exchange) material, particularly by any available technique, such as e.g. printing or photoinitiated grafting techniques or self-assembly (adsorption) during dip coating or spraying.

Further, according to an embodiment of the present invention, the porous membrane of the membrane assembly of the at least one electro-osmotic pump comprises pores having a pore size between 1 nm and 3000 nm, particularly between 1 nm and 1000 nm, preferably between 100 nm and 400 nm.

Further, according to an embodiment of the present invention, the pore size (or average pore size) is the pore size measured by a bubble point test, which is described in American Society for Testing and Materials Standard (ASMT) Method F316. Other methods to measure pore size may also be employed.

Further, according to an embodiment of the present invention, the pore density is preferably above 1 pore per 10 μm² to maximize the total electroosmotic flow.

Further, according to an embodiment of the present invention the membrane assembly of the at least one electro-osmotic pump comprises a thickness smaller than 200 μm, preferably smaller than 100 μm, most preferably smaller than 50 μm. Particularly, this thickness allows the assembly of a contact lens with total thickness of less than 500 μm, preferably less than 400 μm.

Further, according to an embodiment of the present invention each of the two electrodes of the membrane assembly of the at least one electro-osmotic pump comprises a thickness that is smaller than 40 μm, preferably smaller than 10 μm. Particularly, the thickness can be less than 2.5 μm.

Further, according to an embodiment of the present invention, the membrane assembly (e.g. with the two porous layers or without the two porous layers) that is smaller than 100 μm, particularly smaller than 50 μm. Particularly, said thickness can be 25 μm to provide flexibility of the lens and compliance during assembly.

Further, according to an embodiment of the present invention, the electrodes of the membrane assembly are one of: deposited on the porous (e.g. nanoporous) membrane without clogging or altering the pores of the porous membrane, for instance by means of metal sputtering; laminated and/or fixed with an adhesive on the porous (e.g. nanoporous) membrane, particularly without obstructing pores of the porous membrane. Furthermore, according to an embodiment, the respective electrodes may be formed by a conductive, porous structure itself, such as a metal mesh or a perforated thin sheet, or a conductive composite of polymer material that has porosity or has been treated such that pores are created.

Further, according to an embodiment of the present invention, the respective electrode of the membrane assembly is formed out of or comprises one of the following materials: a conductive polymer, e.g. PPy (polypyrrole) or PEDOT; MWCNT; silver nanotubes; graphene; activated carbon coating; a sputtered noble metal film (e.g. Au, Pt, Ag, or Ir). Furthermore, metal meshes, perforated or porous metal sheets, conductive composite materials, such as conductive adhesives or glues, or hybrid materials such as PEDOT:PSS or graphene/silver nanowires in binder material can be used as materials for the respective electrode.

Each of these materials can be either applied directly onto the porous electro-osmotic membrane material, or alternatively to reduce the risk of plugging the pores of the electro-osmotic (porous) membrane they can be deposited on a porous inert substrate material or fabric with large mesh size, and the resulting electrode sheet can be laminated or glued onto the electro-osmotic (porous) membrane.

Further, according to an embodiment of the present invention, the respective electrode may comprise at least one, several or all of the following electrical properties: a low sheet resistance, particularly smaller than 1 kOhm, preferably smaller than 100 Ohm, most preferably smaller than 50 Ohm, and/or a low impedance at 1 kHz, that is particularly smaller than 100 kOhm, preferably smaller than 10 kOhm, most preferably smaller than 1 kOhm.

Further, according to an embodiment, the respective electrode of the membrane assembly may form a capacitive or pseudo-capacitive electrode.

Further, according to an embodiment of the present invention, the liquid comprises a viscosity that is preferably below 100 mPas, most preferably below 5 mPas (e.g. such as for water) in order to require smaller pressure gradients for a desired flow velocity of the liquid. Particularly, the liquid can be pumped fast enough to allow tuning of the lens within a desired time interval. Particularly, the liquid has to rapidly flow through the at least one channel (as well as through the porous membrane) so that liquids with a low viscosity such as water are preferred. Preferably, according to an embodiment, the liquid residing in the lens volume and reservoir volume comprises water as a predominant component.

Further, according to an embodiment of the present invention, the liquid has a dielectric constant between 10 and 100, preferably between 50 and 100, such as water, to increase the intensity of the electric field.

Further, according to an embodiment of the present invention, the pH value of the liquid should be between 5 and 9, preferably between 6 and 8, in order not to reduce an amplitude of zeta potential and decrease an efficiency of the at least one electro-osmotic pump.

Further, particularly fluidic lenses are usually not filled with a liquid having water as a main (or sole) component as water evaporates through said transparent and elastically deformable membrane of the lens (e.g. elastomers are not a good barrier to water molecules in gas phase).

However, according to an embodiment, said liquid comprises water as a main (i.e. predominant) component, which enables the use of an electro-osmotic pump for tuning the focal length or focal power of the lens (particularly contact lens).

In order to prevent water to escape from the lens or reservoir volume and maintain the volume of water constant in the lens (e.g. contact lens), an inside and/or an outside of the lens can be coated. One particular example for applying a coating to prevent water to escape is to apply either the inside or the outside of the lens with one of the following materials (providing barrier properties for water): a parylene coating, a multi-layer coating comprising parylene layers and transparent metal oxide layers, a liquid glass coating. An example of a coating system that will help to maintain the water in the lens is similar to the system used for commercial soft contact lenses based on e.g. hydrogel materials. In this embodiment, a hydrogel coating is applied on the outer surface of the lens. The hydrogel material has a high water content which reduces the osmotic force for water inside the lens to move out. Furthermore, the hydrogel coating layer on the outside of the lens in contact and exchange with the tear liquid on the surface of the eye ball. This tear film around the lens has a certain salt concentration. In order to avoid an osmotic effect resulting in the escape of water from the lens, the same salt concentration can be used for the water (liquid) in the lens volume and reservoir volume.

However, at a physiological concentration of salt in the water (liquid) of the lens, the efficiency of the electro-osmotic pump is greatly reduced as the Debye length is decreased significantly.

Therefore, according to a preferred embodiment, the liquid of the lens comprises deionized (DI) water or a water solution having a low salt concentration (e.g. smaller or equal to 3 mM). Furthermore, the liquid comprises mannitol having a concentration between 4 wt % to 6 wt %, most preferably 5 wt %, particularly to ensure isotonicity with tear liquid and to avoid an osmotic effect. Mannitol tends to acidify the water solution by releasing protons. A low pH may reduce the efficiency of the electro-osmotic pump. Particularly, mannitol (C₆H₁₄O₆) has the CAS number 69-65-8.

Thus, furthermore, according to an embodiment, the liquid may comprise a buffer, particularly so as to keep the pH at a value between 6 and 8 and particularly to avoid any pH fluctuations that would change the performances of the lens. As the lens is filled with water and mannitol and may be stored for extended period of time, the lens is sterilized according to an embodiment and/or may further comprise an anti-bacterial agent and/or a fungicide according to an embodiment.

Further, according to an embodiment of the present invention, the electrodes of the membrane assembly of the at least one electro-osmotic pump are transparent (e.g. the respective electrode can be a mesh electrode or can be formed out of or can comprise: nanowires, nanotubes, graphene, ITO). Further, according to an embodiment, the index of refraction of the porous membrane is matched to the index of refraction of the liquid residing in the lens volume and the reservoir volume of the lens.

Further, according to an embodiment, the lens comprises a covering element for covering the (e.g. non-transparent) membrane assembly, particularly so as to hide the e.g. non-transparent membrane assembly behind said covering element.

Particularly, in an embodiment, the covering element may comprise a colored surface, that is particularly matched to a color of an eye of a user, on which eye the lens is to be placed (e.g. contact lens). Particularly, the colored surface is configured to mimic an appearance of a human iris (particularly of the user, i.e. the person wearing the contact lens). Particularly, the colored surface can be formed by a photograph of a human iris (e.g. of said user), which photograph is arranged (e.g. printed) on the covering element.

Further, according to an embodiment of the present invention, the lens is one of:
a contact lens configured to be placed on a surface of an eye of a person (user),
an intraocular lens configured to be placed inside an eye of a person (user).
a lens that is configured to be placed in front of an eye of a person (user), particularly spaced apart from said eye.

Furthermore, according to an embodiment of the present invention, the lens (particularly said charging device) comprises a coil for charging the energy source and/or for powering the lens in a wireless fashion (e.g. using electromagnetic induction), wherein conductors of the lens (particularly the first and the second electrode) other than said coil do not form a closed loop and/or wherein the first and the second electrode comprise an open annular shape (or form an open loop). Particularly, the first and the second electrode can each form an open loop of less than 360° (e.g. of almost 360°), and are configured to not let electric current flow in a closed loop). Using no closed-loop conductors (besides said coil) helps to prevent interference of electromagnetic fields used for charging/powering the lens with electronics of the lens.

Yet another aspect of the present invention relates to a pair of contact lenses comprised of two lenses according to the present invention, wherein one of the lenses is configured to be placed on a surface of a left eye of a person, and wherein the other lens is configured to be placed on a surface of a right eye of a person.

Yet another aspect of the present invention relates to spectacles for vision correction comprising two lenses according to the present invention.

Furthermore, yet another aspect of the present invention relates to a method for producing a membrane assembly for an electro-osmotic pump, comprising the steps of:
providing a flat membrane assembly sheet comprising a porous membrane having a top surface and a bottom surface that faces away from the top surface, wherein an electrode layer is arranged on the top surface, and wherein an electrode layer is arranged on the bottom surface,
separating a curved portion of the flat membrane assembly sheet from the flat membrane assembly sheet to obtain a curved membrane assembly having opposing ends,
bonding said opposing ends to one another by a liquid-tight connection to form the membrane assembly into a conical frustum shape.

Furthermore, according to an embodiment of the method, the conical frustum shaped membrane assembly can further be formed into a spherical segment.

This can be done by e.g. placing the conical frustum shaped membrane assembly in a forming tool having the desired curved shape, and subsequently exposing it to an elevated temperature (e.g. between 60 and 280° C., particularly between 60° C. and 130° C.) and pressure (e.g. between 1 bar and 3 bar) for a defined period of time (e.g. 1 s to 10 min, particularly 0.5 min to 10 min). Particularly, this procedure can be done with any thermoplastic material or thermally deformable material.

Furthermore, according to an embodiment of the method according to the present invention, the electrode material for forming the electrodes and/or the material for forming the porous membrane is/are preferably selected such that the membrane assembly of the respective electro-osmotic pump can be formed or processed in a single process step. Preferably, electrode materials are used that resemble the material selected for the porous membrane of the electro-osmotic pump.

Besides contact lenses, the present invention can be used in a large variety of applications that require an adjustable focal length including ophthalmology equipment such as phoropters, refractometers, pachymeters, biometrie, perimeters, refrakto-keratometers, refractive lens analyzers, tonometers, anomaloscop, contrastometers, endothelmicroscopes, anomaloscopes, binoptometers, OCT, rodatests, ophthalmoscopes, RTA or in lighting, machine vision, laser processing, mobile phone cameras, light shows, printers, metrology, head worn glasses, medical equipment, robot cams, motion tracking, microscopes, telescopes, endoscopes, binoculars, research, surveillance cameras, automotive, projectors, ophthalmic lenses, range finder, bar code readers, web cams.

The invention will be better understood and objects other than those set forth above will become apparent when consideration is given to the following detailed description thereof. Such description makes reference to the drawings, wherein:

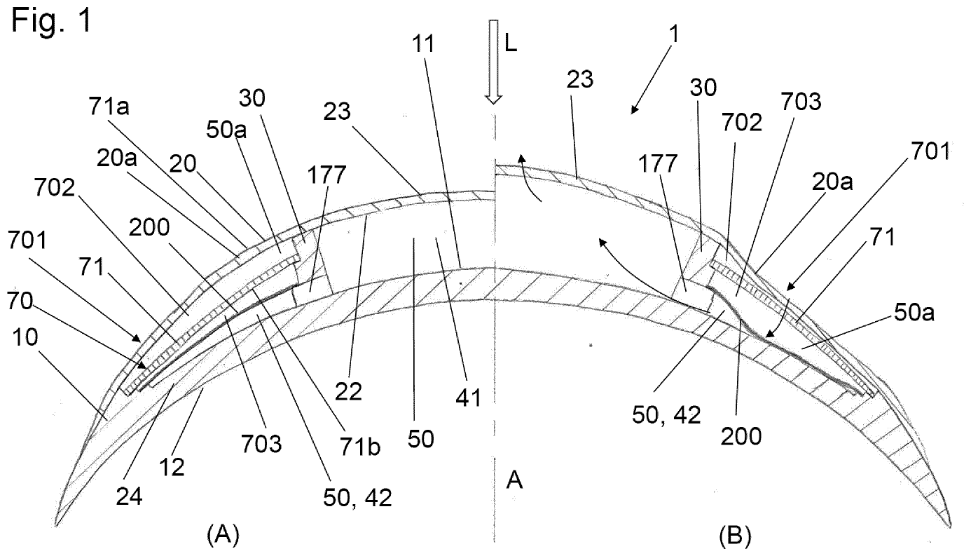

FIG. 1 shows a schematical cross-sectional view of an embodiment of the lens according to the present invention using an actuator membrane for indirect pumping, wherein a resting state (A) and a tuned state of the lens are shown (B);

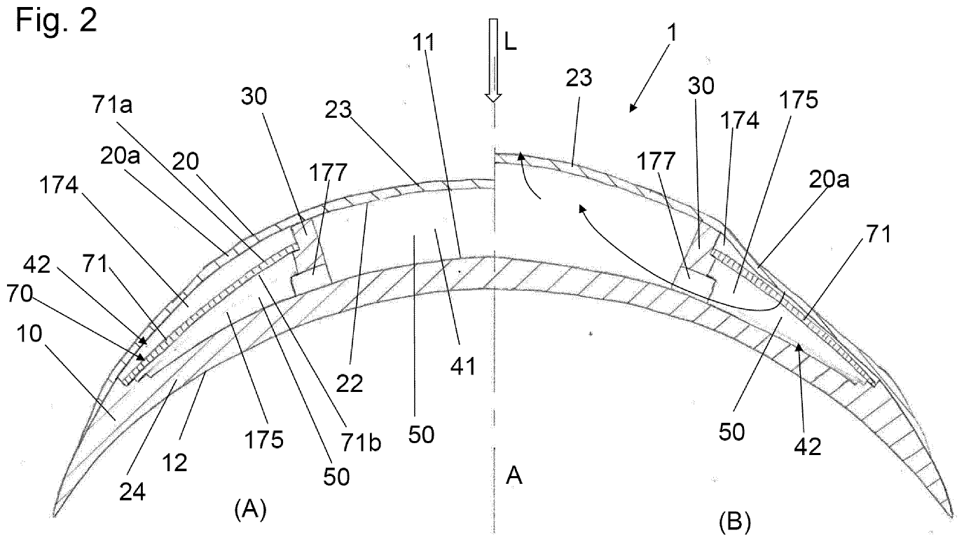

FIG. 2 shows a schematical cross-sectional view of an embodiment of the lens according to the present invention using direct pumping of the liquid of the lens by means of at least one electro-osmotic pump, wherein a resting state (A) and a tuned state of the lens are shown (B);

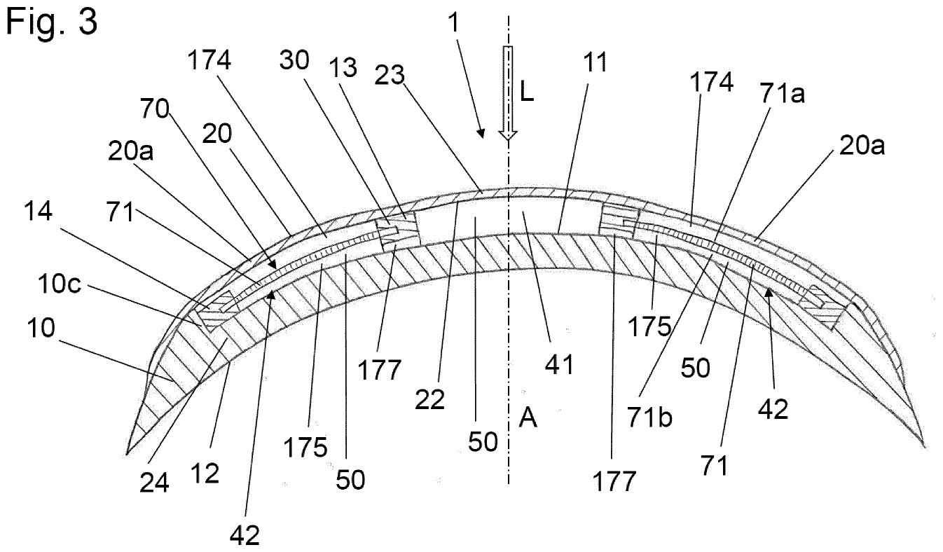

FIG. 3 shows a schematical cross-sectional view of an embodiment of the lens according to the present invention, wherein the membrane assembly is connected to an inner and an outer annular structure;

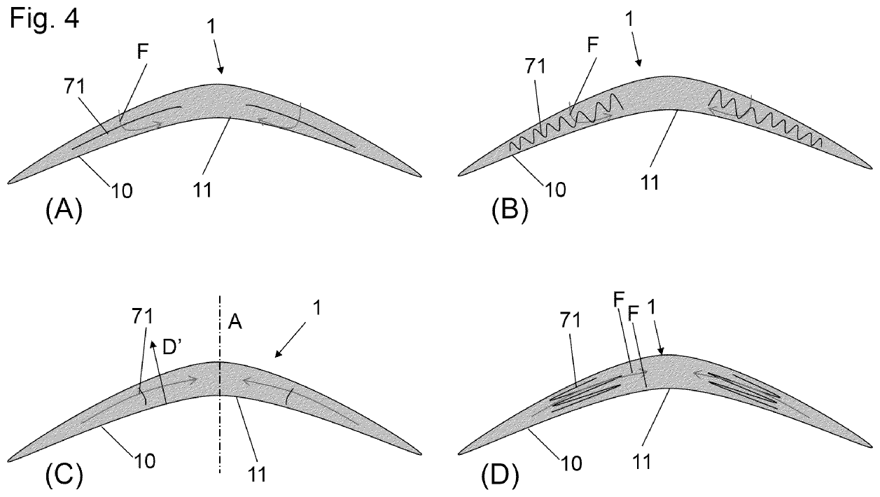

FIG. 4 shows a schematical cross-sectional views of different shapes and orientations of the membrane assembly of the electro-osmotic pump;

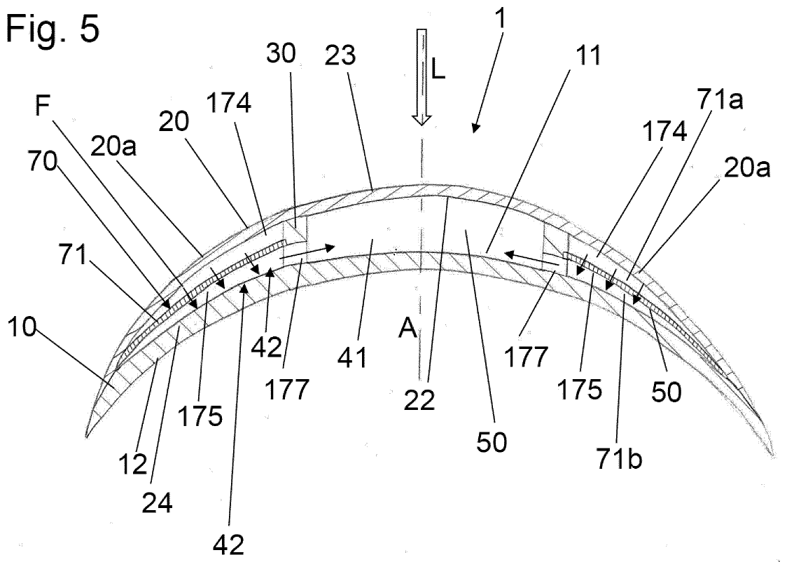

FIG. 5 shows a schematical cross-sectional view of an embodiment of the lens according to the present invention, wherein the membrane assembly extends along the front side of the base element of the lens;

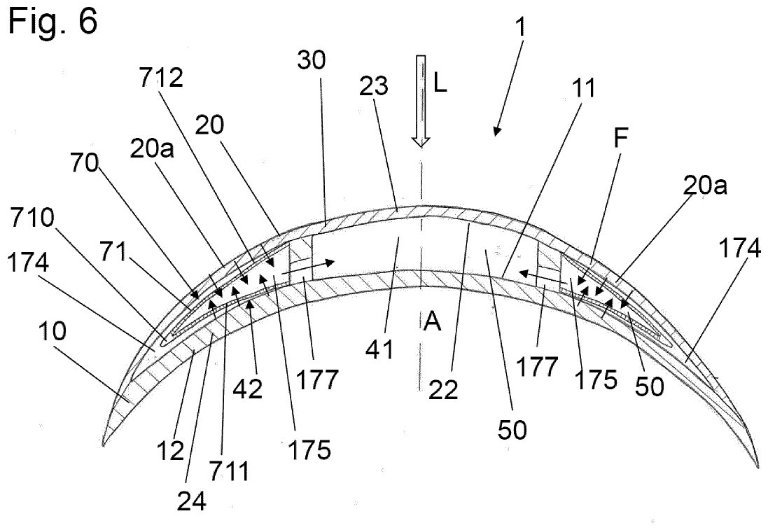

FIG. 6 shows a schematical cross-sectional view of an embodiment of the lens according to the present invention having a folded membrane assembly extending along the front side of the base element of the lens;

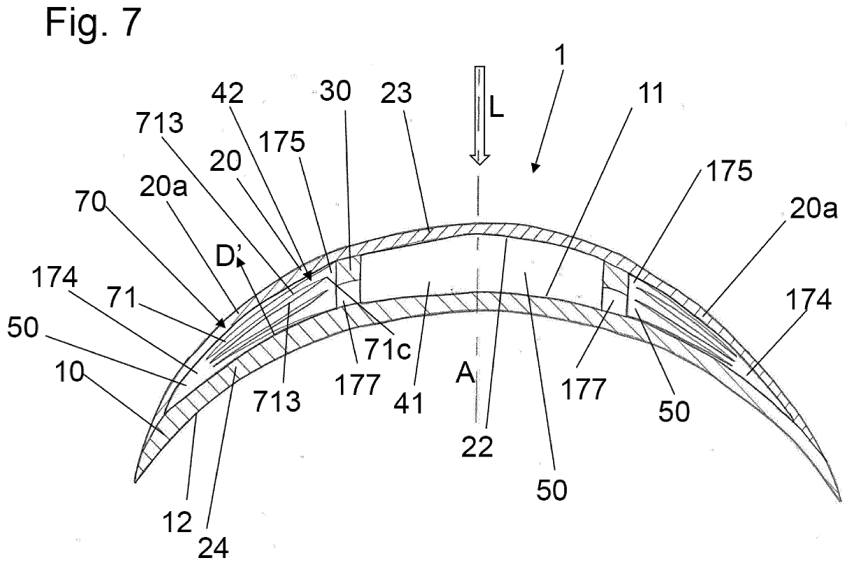

FIG. 7 shows a schematical cross-sectional view of an embodiment of the lens according to the present invention comprising a bellows shaped membrane assembly;

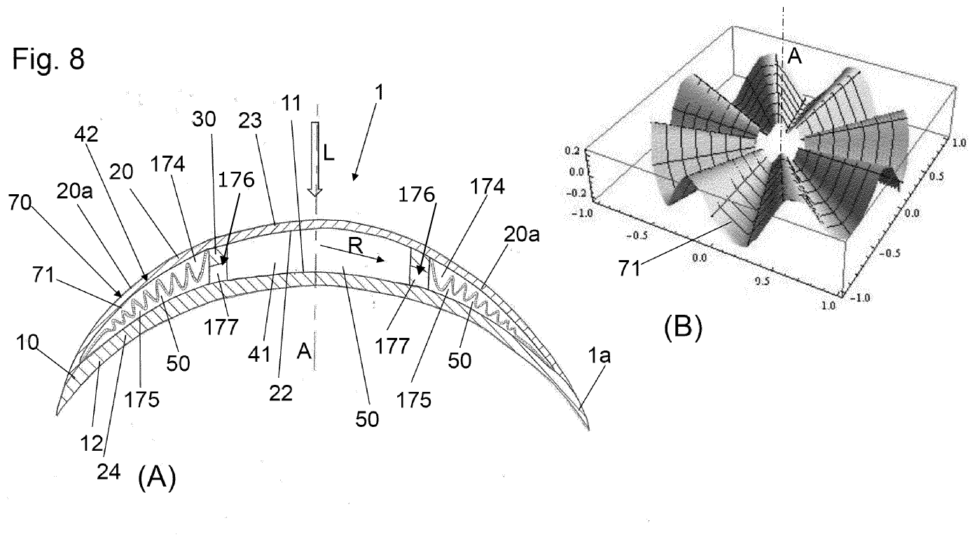

FIG. 8 shows a schematical cross-sectional view of an embodiment of the lens according to the present invention having an undulated membrane assembly in a direction pointing outside from the lens volume along the front side of the base element (A) and a membrane assembly being undulated in a peripheral direction of the lens (B);

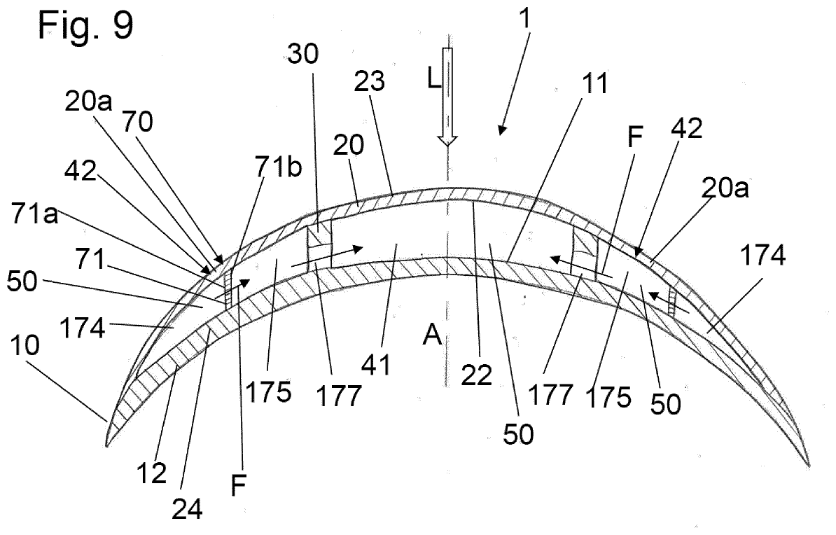

FIG. 9 shows a schematical cross-sectional view of an embodiment of the lens according to the present invention having a membrane assemble that extends along a direction extending parallel to the optical axis of the lens;

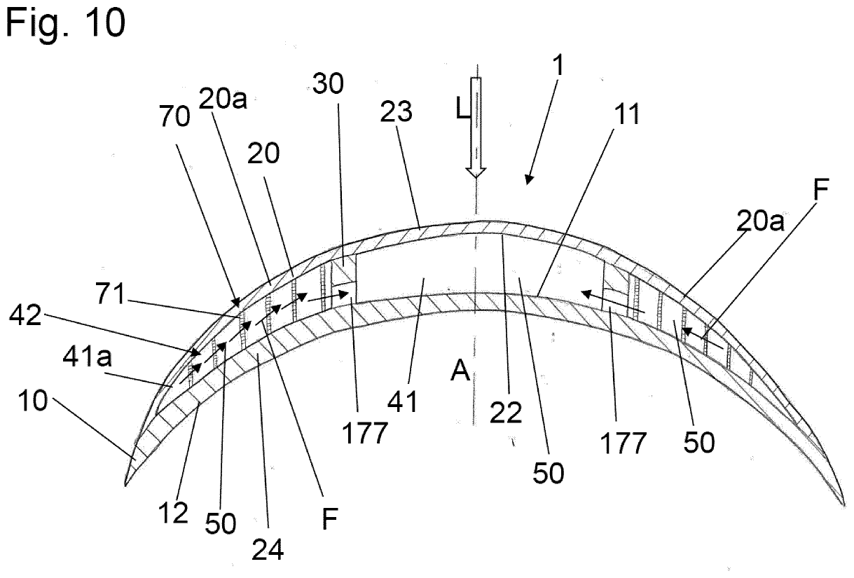

FIG. 10 shows a schematical cross-sectional view of an embodiment of the lens according to the present invention comprising a membrane assembly of an electro-osmotic pump having a spiral shape;

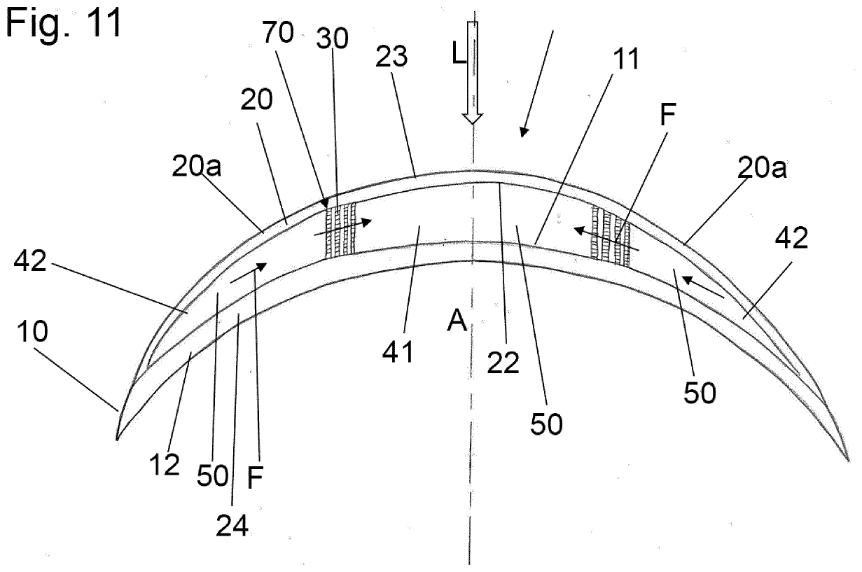

FIG. 11 shows a schematical cross-sectional view of an embodiment of the lens according to the present invention comprising a membrane assembly of an electro-osmotic pump having a spiral shape, wherein said spiral shaped membrane assembly also forms the lens shaping member;

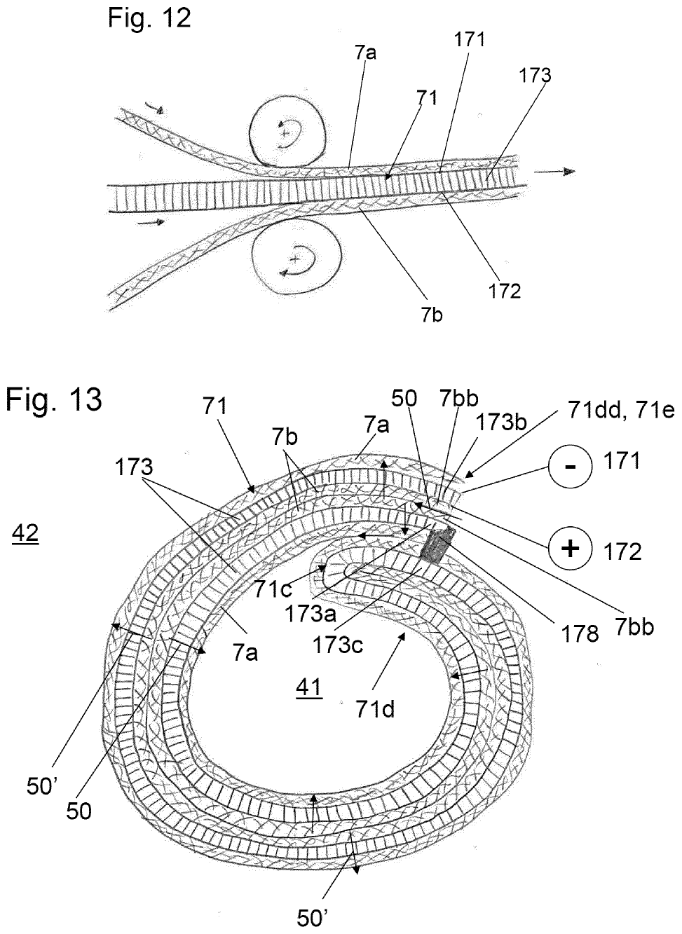

FIG. 12 shows a schematical cross-sectional view of producing a membrane assembly comprising a porous membrane sandwiched between two electrodes, wherein the latter structure is sandwiched between two porous layers acting as spacers;

FIG. 13 shows a schematical plan view of a membrane assembly formed into a folded structure forming a spiral (only one turn shown);

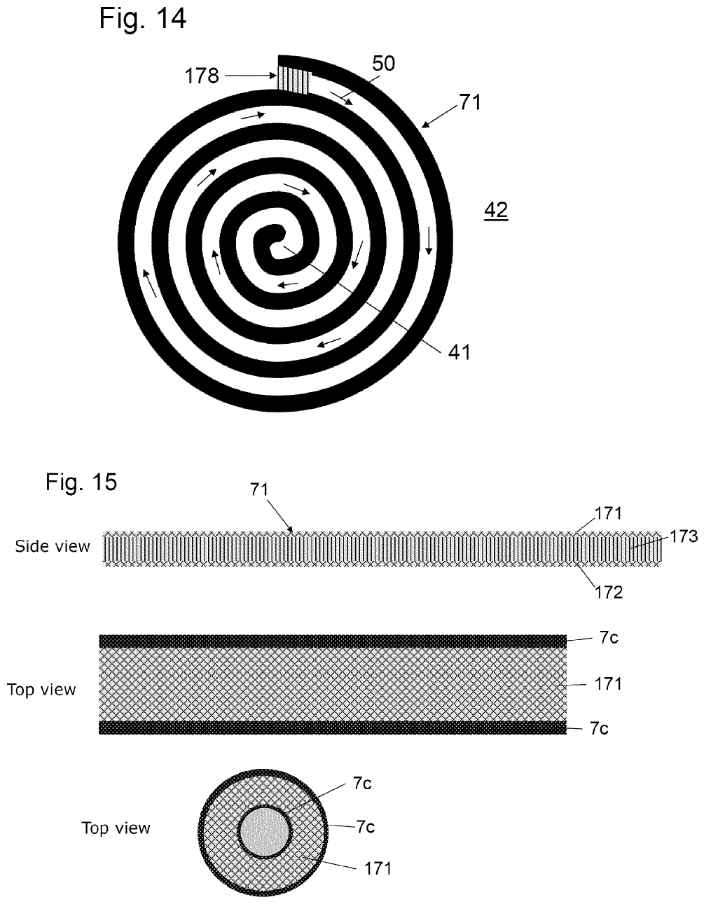

FIG. 14 shows a further schematical plan view of a spiral shaped membrane assembly using a folded structure shown in FIG. 13;

FIG. 15 shows a schematical side view and top views of a membrane assembly of an electro-osmotic pump comprising elongated conductors comprising gold (Au);

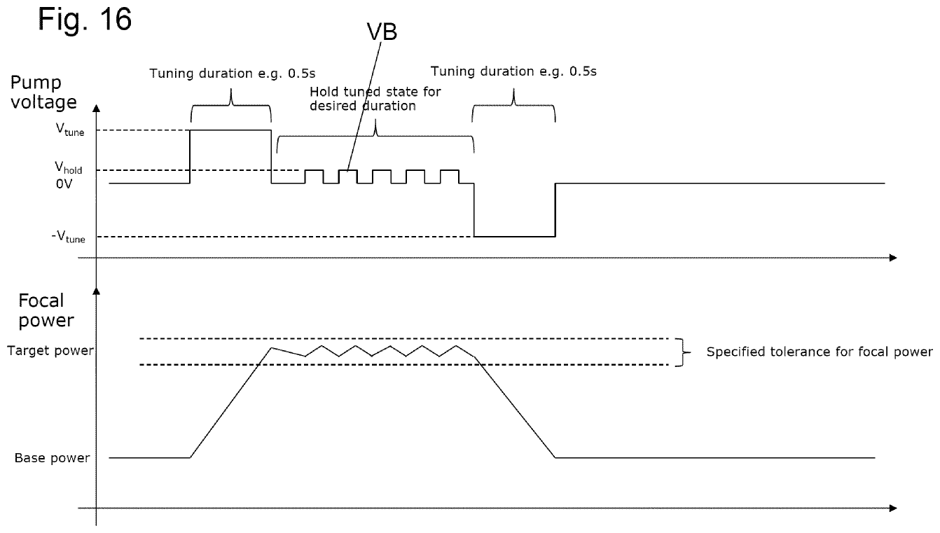

FIG. 16 shows an example of controlling of the voltage applied to the electrode of the at least one electro-osmotic pump for adjusting the focal length of the lens;

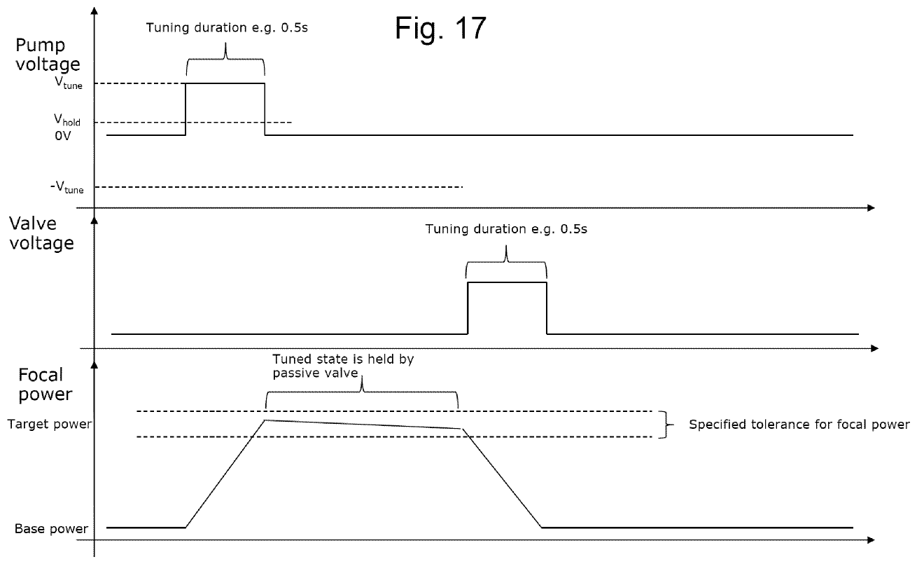

FIG. 17 shows an example of controlling of the voltage applied to the electrode of the at least one electro-osmotic pump for adjusting the focal length of the lens using a passive valve of holding a tuned state of the lens;

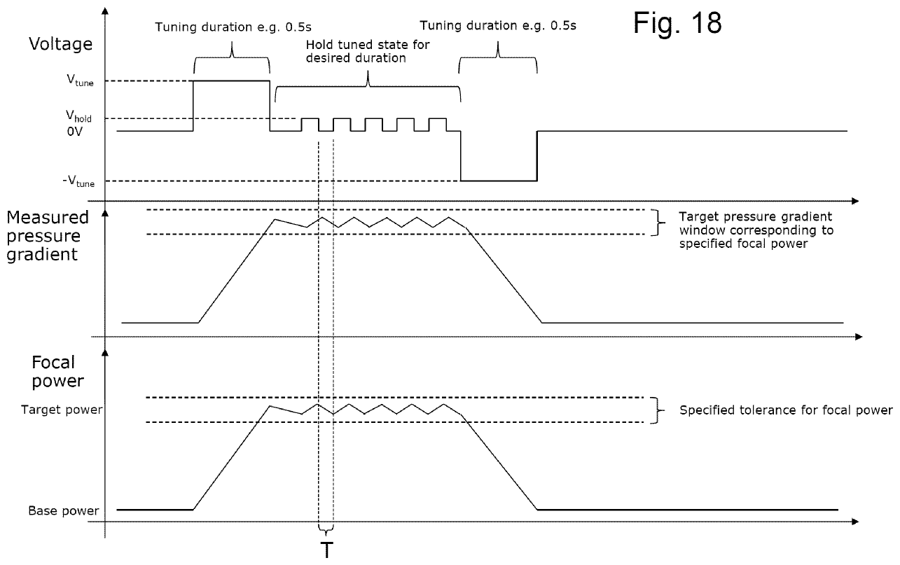

FIG. 18 shows an example of controlling of the voltage applied to the electrode of the at least one electro-osmotic pump for adjusting the focal length of the lens using measuring the streaming potential/pressure gradient across the porous membrane;

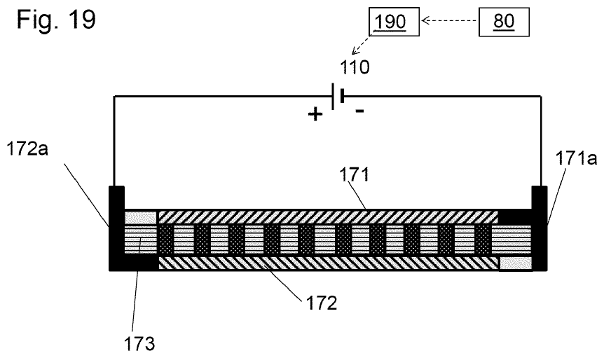

FIG. 19 shows a schematical view of an energy source connected to the electrodes attached to the porous membrane;

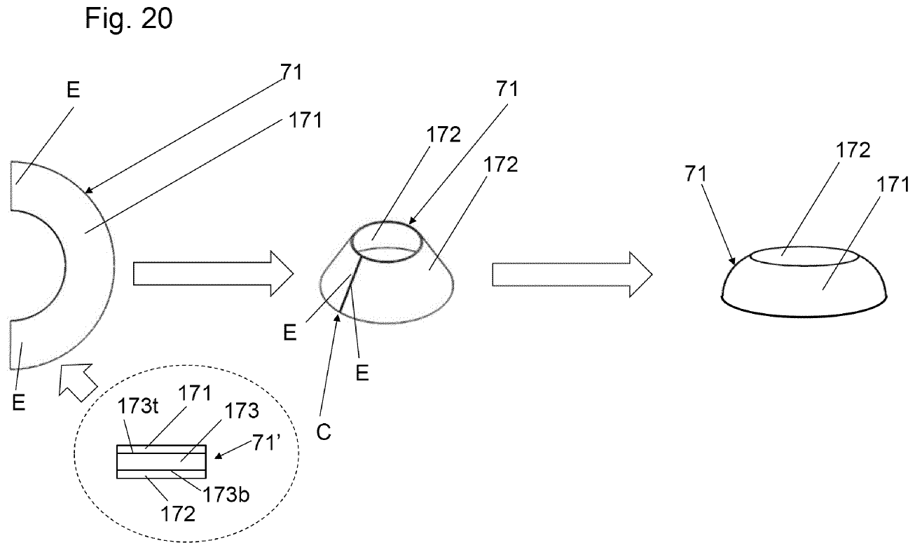

FIG. 20 illustrates a method for forming a membrane assembly having the shape of a conical frustum or of spherical segment;

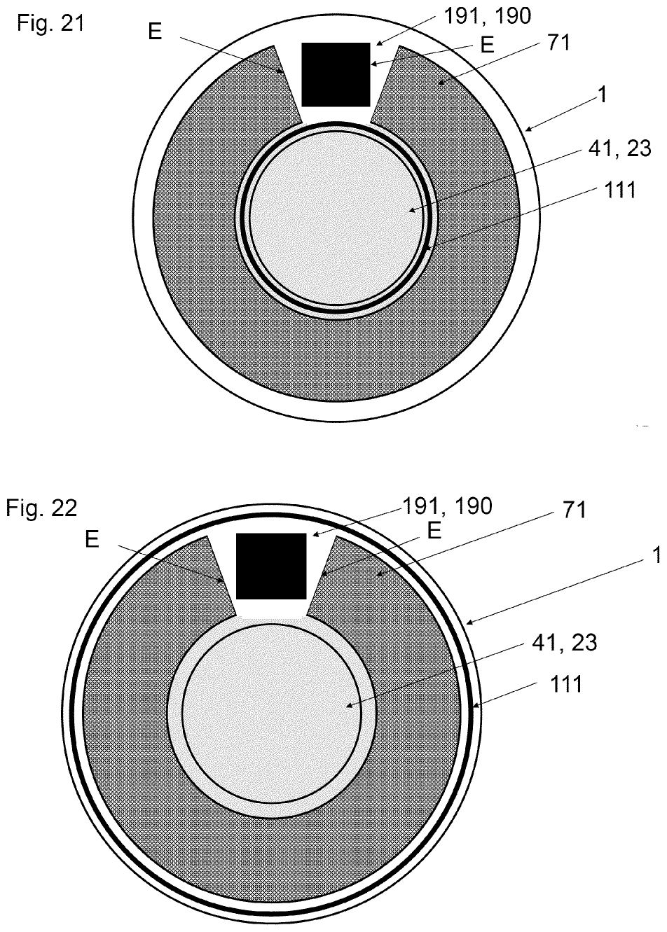

FIG. 21 shows an embodiment of the lens comprising a coil for wireless charging/powering of the lens; and

FIG. 22 shows a modification of the embodiment shown in FIG. 21.

FIG. 1 shows an embodiment of a lens 1, here in form of a contact lens 1, according to the present invention. Particularly, the lens 1 comprises a transparent base element 10 having a back side 12, and a front side 11 facing away from the back side 12, a transparent and elastically expandable membrane 20 connected to said base element 10, wherein said membrane 20 comprises a back side 22 that faces said front side 11 of the base element 10, and a lens shaping member 30 (e.g. ring member or ring structure) connected to said the membrane 20 so that the lens shaping member 30 defines an area 23 of the membrane 20, which area 23 comprises an adjustable curvature. Further, the lens 1 comprises a lens volume 41 adjacent said area 23 of the membrane 20, which lens volume 41 can be delimited (or enclosed) by the lens shaping member 30, by the membrane 20, and by the base element 10. Furthermore, the lens 1 comprises an (e.g. circumferential) reservoir volume 42 arranged in a boundary or peripheral region 24 of the lens 1, wherein said two volumes 41, 42 are each filled with a transparent liquid 50.

In order to adjust the curvature of said area 23 of the membrane 20, the lens 1 further comprises an electro-osmotic pump 70 configured to transfer transparent liquid 50 from the reservoir volume 42 to the lens volume 41 or vice versa such that the curvature (or deflection) of said area 23 of the membrane 20 changes and the focal length of the lens 1 changes. Thus, light L passing through the lens volume 41 (e.g. via the area 23, the liquid 50 and the base element 10) can be influenced in a variable manner according to the adjusted curvature of said area 23 which corresponds to a certain focal power or focal length of the lens 1.

Particularly, the electro-osmotic pump 70 comprises a membrane assembly 71 comprising a porous membrane 173 sandwiched between a first (e.g. top) electrode 171 and a second (e.g. bottom) electrode 172 of the assembly 70 as e.g. shown in FIGS. 15 and 19. Particularly, as shown in FIG. 15, each of said electrodes 171, 172 of the membrane assembly 71 of the at least one electro-osmotic pump can comprise two opposing conductors 7c that can extend along an edge of the respective electrode 171, 172. Particularly, in case the porous membrane 173/membrane assembly 71 comprises the shape of a conical frustum or of a spherical segment (c.f. lower part of FIG. 15) the elongated conductors 7c can extend along the inner and outer edge of the respective electrode 171, 172. Particularly, these elongated conductors 7c are intended to ensure that a voltage drop (and hence field strength applied) over the membrane assembly 71 is limited.

Furthermore, the lens 1 comprises an energy source 110 (e.g. a battery, particularly a rechargeable battery, or a capacitor, for providing a voltage that is applied to said electrodes 171, 172 so as to pump liquid 50 by means of the electro-osmotic pump 70.

Particularly, as shown in FIG. 19, said electro-osmotic pump 70 can comprise a first contact lead 171a for connecting a battery 110 to the first electrode 171, and a second contact lead 172a for connecting said battery 110 to the second electrode 172, wherein particularly said first contact lead 171a can be arranged at an end of the first electro-osmotic pump 70. Further, particularly, said second contact lead 172a can also be arranged at an end of the electro-osmotic pump 70.

Particularly, the energy source 110 can be arranged in the reservoir volume 42 or outside the reservoir volume 42, particularly, the energy source can be mounted to the porous membrane 173.

Further, as shown in FIG. 1, the base element 10 can comprises a recess on the front size 11 for accommodating the reservoir volume 42 and the lens volume 41, which volumes are particularly covered by the membrane 20 that is particularly bonded to the front side of the base element 10.

For transferring liquid 50 between the lens volume 41 and the reservoir volume 42, which allows to tune the focal length of the lens 1 by pumping the liquid correspondingly, the lens comprises an actuator membrane 200 which separates the reservoir volume 42 from a pump volume 701, wherein the membrane assembly 71 of the electro-osmotic pump 70 separates the pump volume 701 into a first region 702 and a second region 703, wherein the second region 703 of the pump volume 701 is arranged between the membrane assembly 71 and the actuator membrane 200.

As indicated in FIG. 1 said regions 702, 703 of the pump volume 701 can be arranged on top of one another.

Furthermore, the lens volume 41 and the reservoir volume 42 are filled with said transparent liquid 50, wherein the first region 702 and the second region 703 of the pump volume 701 are filled with a pumping liquid 50a (which pumping liquid can be identical to or different from the liquid 50).

In order to transfer now liquid 50 from the reservoir volume 42 to the lens volume 41 so as to increase the curvature/deflection of said area 23 and therewith the focal power of the lens 1, the electro-osmotic pump 70 is configured to pump pumping liquid 50a through the porous membrane 173 from the first region 702 of the pump volume 701 into the second region 703 of the pump volume 701 so as to press pumping liquid 50a against the actuator membrane 200 such that the actuator membrane 200 in turn pushes liquid 50 residing in the reservoir volume 42 into the lens volume 41. FIG. 1(B) shows the increased deflection of the area 23 in contrast to the resting state shown in FIG. 1(A).

Likewise, in order to transfer liquid 50 from the lens volume 41 to the reservoir volume 42, the at least one electro-osmotic pump 70 is configured to pump pumping liquid 50a through the porous membrane 173 from the second region 703 of the pump volume 701 into the first region 702 of the pump volume 701 so that the actuator membrane 200 draws liquid out of the lens volume 41 into the reservoir volume 42.

As the lens volume 41 is surrounded by the lens shaping member 30, one or several channels 177 can be arranged in the lens shaping member 30 for connecting the reservoir volume 42 to the central lens volume 41.

FIG. 2 shows an embodiment that is basically configured as shown in FIG. 1, wherein in contrast to FIG. 1, the embodiment according to FIG. 2 allows direct pumping of the liquid 50. Here, the actuator membrane 200 is omitted, and said membrane assembly 71 now separates a first region 174 of the reservoir volume 42 from a second region 175 of the reservoir volume 42.

Again, said regions 174, 175 of the reservoir volume 41 can be arranged on top of one another as indicated in FIG. 2.

Furthermore, the lens volume 41 and the first and the second region 174, 175 of the reservoir volume 42 are filled with the (same) transparent liquid 50, wherein particularly the porous membrane 173 (or membrane assembly) is in flow connection with the lens volume 41 via the second region 175 of the reservoir volume 42 or can at least be brought in flow connection with the lens volume 41 (e.g. in case a valve is arranged in a flow path between the reservoir volume and the lens volume, see also below).

Furthermore, in order to transfer said liquid 50 from the reservoir volume 42 to the lens volume 41 for increasing the focal power of the lens 1, the electro-osmotic pump 70 is configured to pump liquid 50 from the first region 174 of the reservoir volume 42 into the second region 175 of the reservoir volume 42. Further, particularly, in order to transfer said liquid 50 from the lens volume 41 to the reservoir volume 42 so as to decrease the focal power of the lens 1, the electro-osmotic pump is configured to pump liquid from the second region of the reservoir volume into the first region (175) of the reservoir volume.

FIG. 3 shows a further embodiment of a lens according to the present invention using the concept of pumping the liquid 50 directly as described in conjunction with FIG. 2. Particularly, according to FIG. 3, the lens further comprises an inner annular structure 13 and an outer annular structure 14, wherein the membrane assembly 71 (or the electro-osmotic pump), particularly the porous membrane 173 and said electrodes 171, 172, is connected to the outer and the inner annular structure 13, 14. Further, particularly, said membrane assembly and said annular structures form a sub-assembly of the lens.

Furthermore, the base element 10 of the lens comprises a step 10c, preferably in form of a circumferential step 10c extending along a periphery of the base element 10 for aligning the membrane assembly 71 with respect to the base element 10. Particularly, the circumferential step 10c is configured for aligning the outer annular structure 14 connected to the membrane assembly 71 with respect to the base element 10, wherein particularly the outer annular structure is arranged on the step 10c in a form-fitting fashion as indicated in FIG. 3.

Furthermore, making the design even more compact, the lens shaping member 30 is formed by the inner annular structure 13, which is bonded to the front side 11 of the base element 10 and to the back side 22 of the membrane 20, so that said area 23 of the membrane 20 is defined by an inner circular edge of the inner annular structure.

Further, the outer annular structure 14 forms a sealing member that is adapted to prevent liquid 50 from leaking around the membrane assembly 71, wherein the outer annular structure 14 is bonded to the front side 12 of the base element 10, particularly at said step 10c.

Regarding the embodiments shown in FIGS. 1 to 3, the first region 702 of the pump volume (cf. FIG. 1) or the first region 174 of the reservoir volume 42 is at least partially delimited by an elastically deformable wall 20a. Particularly, as shown in FIGS. 1 to 3 this wall is formed by a portion 20a of the transparent and elastically expandable membrane 20.

Concerning the shape and orientation of the membrane assembly 71 of the electro-osmotic pump 70, FIG. 4 summarizes different possibilities/embodiments.

Particular embodiments of the configuration shown in FIG. 4(A) are shown in FIGS. 1 to 3, and FIG. 5. In these embodiments, the respective membrane assembly 71 extends along the front side 11 of the base element 10 so that the membrane assembly 71 comprise a first side 71a and a second side 71b facing away from the first side 71a, wherein the first side 71a faces away from front side 11 of the base element 10, and wherein the second side 71b faces the front side 11 of the base element 10. Particularly, here, the membrane assembly 71 can have a curved shape, particularly a circumferential shape, e.g. the shape of a spherical segment or a conical frustum.

Further, as indicated in FIG. 4(B), the membrane assembly 71 can in addition comprise an undulated shape. Specific embodiments are shown in FIGS. 8(A) and 8(B).

Particularly, as shown in FIG. 8(A), the membrane assembly 71 can comprises an undulated shape in a direction R pointing from a center of the lens volume 41 towards a periphery 1a of the lens 1. Alternatively, as shown in FIG. 8(B) the membrane assembly 71 can comprise an undulated shape in a peripheral direction of the lens 1.

Furthermore, in the embodiment shown in FIG. 8(A) the lens may optionally comprise at least one active valve 176, wherein the lens 1 may be configured to actively open and close the at least one channel 177 using the valve 176 as described herein. Such an active valve or several active valves can optionally be used also in other embodiments of the present invention (particularly in case one or several channels, e.g. 177, are present).

In the above described configurations relating to FIGS. 4(A) and 4(B), the respective membrane assembly 71 of the electro-osmotic pump 70 is configured to generate a flow F of the liquid 50 that is directed towards the front side 11 of the base element 10 or away from the front side of the base element 10.

Furthermore, FIG. 4(C) shows a configuration of the membrane assembly 71, where the membrane assembly 71 extends along a direction D′ normal to the front side 11 of the base element 10 or along a direction parallel to the optical axis A of the lens 1, such that the membrane assembly 71 comprises a first side 71a facing away from an optical axis A of the lens 1 and a second side 71b facing said optical axis A as shown in FIG. 9.

Further configurations of this kind are shown in FIGS. 10 and 11, wherein here the membrane assembly 71 comprises a spiral shape in order to increase efficiency of the pump 70. These spiral configurations will be described in detail further below.

Furthermore, as indicated in FIG. 4(D), the membrane assembly 71 can comprise sections connected to one another that are stacked on top of one another.

Particularly, in the configurations shown in FIGS. 4(C) and 4(D), the electro-osmotic membrane assembly 71 is configured to generate a flow F of the liquid 50 that is directed along the front side 11 of the base element 10 and particularly perpendicular to said first or second side of the membrane.

Furthermore, for instance, according to a first embodiment shown in FIG. 6, the membrane assembly 71 comprises a curved portion 710 (e.g. a crease, particularly a circumferential crease) such that the membrane assembly 71 comprises a first section 711 and a second section 712 connected via the curved portion/crease 710 and facing each other, wherein each of said sections 711, 712 of the membrane assembly 710 essentially extends along the front side 11 of the base element 10 of the lens 1. This allows one to double the area of the membrane assembly 71. This gain in surface area can be further increased by forming the membrane in a bellows shape as shown in FIG. 7. Here, the membrane assembly 71 comprises a plurality of curved portions 71c, wherein each curved portion 71c connects two adjacent sections 713 of the membrane assembly 71 to one another such that the membrane assembly 71 comprises a plurality of sections 713 arranged on top of one another in a direction D′ normal to the front side 11 of the base element 10 or in a direction parallel to the optical axis A of the lens 1.

According to a further embodiment of the lens 1 according to the present invention shown in FIG. 10, the membrane assembly 71 forms a spiral extending in a peripheral direction of the lens 1 around an optical axis A of the lens 1, wherein particularly a gap between an end section of an outermost turn of the spiral and an adjacent turn of the spiral arranged further inside is sealed with a seal 178 (cf. e.g. FIGS. 13 and 14) to prevent passage of liquid 50 through said gap.

Further, as shown in FIG. 10 the spiral shaped membrane assembly 71 can be arranged in the reservoir volume 42, where it can extend from a circumferential outer region 41a of the reservoir volume 41 in a spiraling fashion towards the lens shaping member 30, which separates the reservoir volume 42 from the lens volume. Also here, the lens shaping member 30 comprises channels 177 for connecting the reservoir volume 42 to the lens volume 41.

FIG. 11 shows a modification of the embodiment shown in FIG. 10, wherein here the turns of the spiral shaped membrane assembly 71 are more compact, so that the lens assembly 71 itself forms the lens shaping member 30 and separates the reservoir volume 42 from the lens volume 41.

FIGS. 12 to 14 show specific embodiments of the membrane assembly 71 forming a spiral which can be employed in the embodiments shown in FIGS. 10 and 11.

Particularly, according to FIG. 13, the membrane assembly 71 can comprise a first and a second porous layer 7a, 7b, wherein the porous membrane 173 and the two electrodes are sandwiched between the two porous layers 7a, 7b, wherein the first porous layer 7a is connected to the first electrode 171 and the second porous layer 7b is connected to the second electrode 172. The porous layers 7a, 7b act as spacers so that the membrane assembly can be formed into a compact spiral.

Particularly, as shown in FIG. 13, the membrane assembly 71 is folded onto itself to form a folded structure 71 such that two sections 7bb of the second porous layer 7b contact each other and extend side by side, wherein said two sections 7bb form the innermost layers of the folded structure 71. After folding the folded structure 71 is formed into a spiral 71, wherein particularly a crease 71c of the folded structure 71 can form an end of an innermost turn 71d of the spiral.

While FIG. 13 only shows two turns the spiral 71 or folded structure 71 can comprise a plurality of turns 71d. Particularly, the more turns 71d the spiral 71 has, the more insignificant is the circumstance that the outermost section if the porous membrane 173 pumps a portion 50′ of the liquid 50 in the wrong direction, as indicated in FIG. 13.

Since the liquid 50 cannot escape when it is pumped by the membrane assembly towards the center of the lens (e.g. into the lens volume 41) it flows along the spiral shaped folded structure 71 (particularly through the porous layers 7b) as shown in FIG. 14 towards the center of the spiral where the lens volume 41 is arranged.

A way to seal off the spiral 71 is shown in FIG. 13. Particularly, an end section 71e of an outermost turn 71dd of the folded structure 71 comprises an inner portion 173a and an outer portion 173b of the porous membrane 173, which inner and outer portion 173a, 173b are separated by said two sections 7bb of the second porous layer 7b, wherein said inner portion 173a is connected via a liquid-tight seal 178 to a neighboring portion 173c of the porous membrane 173 of an adjacent turn 71d of the spiral 71, which adjacent turn 71d is arranged further inside. Thus liquid 50 can only enter the spiral 71 at the end 71e by flowing along the adjacent porous layer sections 7bb. For the shown polarity of a voltage applied to the electrodes 171, 172, the liquid 50 entering the spiral (e.g. from a reservoir volume 42 surrounding the spiral 71 or being arranged further outside) is pumped through the porous membrane 173 towards the center of the spiral 71 where the lens volume 41 is located as described in conjunction with FIG. 14.

Embodiments for controlling a voltage applied to the electrodes 171, 172 of the electro-osmotic pump 70 are shown in FIGS. 16 to 18.

Particularly, for controlling the voltage, the lens 1 can comprise a processing unit 190 as indicated in FIG. 19 which is configured to prompt the energy source (e.g. battery) 110 to apply a required voltage to the electrodes 171, 172. Further, the processing unit may interact with a sensor 80 that will be described further below in more detail.

In order to transfer said liquid 50 from the reservoir volume 42 to the lens volume 41 using the (e.g. spiral shaped) electro-osmotic pump 70, the latter is configured to pump liquid 50 through the membrane assembly into the lens volume, when a corresponding voltage is applied to the electrodes (as e.g. shown in FIG. 13). Likewise, changing the polarity of the voltage, said liquid 50 can be transferred from the lens volume 41 to the reservoir volume 42.

Regarding controlling of the voltage applied to the electrodes 171, 172, the lens 1 may comprises a sensor 80 configured to detect a state and/or movement of a user of the lens, wherein particularly said movement is an eyelid movement of the user, or wherein particularly said state is a fully closed eyelid, or a partially closed eyelid of the user, and wherein the sensor 80 is configured to generate a corresponding control signal indicative of said state and/or movement.

Particularly, the processing unit 190 can be configured to control said voltage using said control signal.

Particularly as shown in FIG. 16 the processing unit 190 can be configured to hold a desired focal length by causing (prompting) the energy source 110 to apply voltage bursts VB (upper graph of FIG. 16) of amplitude and rate to said electrodes 171, 172 of the membrane assembly 71 that maintain a pressure of the liquid 50 in the lens volume 41 that corresponds to the desired focal length or focal power as shown in the lower graph of FIG. 16.

Furthermore, as shown in FIG. 17, after a voltage has been applied to the electrodes 171, 172, at least one passive valve can be used to maintain the lens in the tuned state, wherein the passive valve reduces or blocks back flow of the liquid from the lens volume 41 into the lens reservoir 42.

Further, the lens 1 may also comprise at least one active valve that is configured to be opened so as to allow liquid 50 to flow back from the lens volume 41 into the reservoir volume for decreasing the focal length (or focal power) of the lens 1. An actuation of such an active valve is shown in the middle graph of FIG. 17, wherein the active valve is opened by applying a voltage to it at the end of the tuned state of the lens (lower graph of FIG. 17).

Furthermore, also a pressure of the liquid in the lens volume 41 can be used to control the voltage applied to the electrodes 171, 172 as shown in FIG. 18.

For this, the lens 1 is particularly configured to measure a pressure of the liquid 50 in the lens volume 41, wherein particularly the lens 1 (particularly the processing unit 190) is configured to determine from the measured pressure of the liquid 50 in the lens volume 41 a focal length (or focal power) of the lens 1. This is possible since the pressure of the liquid in the lens volume correlates well with the focal power/focal length of the lens 1, since a pressure change almost immediately changes the curvature/deflection of said optical active area 23 of the lens 1.

Particularly, for measuring said pressure in the lens volume 41 the lens 1 (particularly said processing unit 190) is configured to measure a streaming potential across the porous membrane 173 using the electrodes 171, 172 of the membrane assembly [which streaming potential is generated by a pressure gradient across pores, particularly nanochannels, of the porous membrane, and wherein the lens 1 (particularly the processing unit 190) is configured to apply said voltage to the electrodes 171, 172 for adjusting the focal length of the lens 1 to a desired value, wherein the lens 1 (particularly the processing unit 190) is configured to repeatedly remove the voltage from the electrodes 171, 172 for a predefined time interval T (e.g. 10 ms, cf. FIG. 18) allowing liquid 50 to flow back from the reservoir volume 42 into the lens volume 41, wherein the lens 1 is configured to measure the streaming potential within the respective time interval T, and wherein the lens 1 (particularly the processing unit 190) is configured to compare the measured streaming potential to an expected value of the streaming potential corresponding to the desired focal length, wherein the lens 1 (particularly the processing unit 190) is configured to adjust said voltage so that the respective measured streaming potential approaches the expected value of the streaming potential.

Regarding charging of an energy source 110 of the lens 1, the lens 1 (particularly said charging device) can comprise a coil 111 for charging the energy source 110 and/or for powering the lens 1 in a wireless fashion (e.g. using electromagnetic induction) as shown in FIGS. 21 and 22. Such a coil 111 can be used with all embodiments of the lens 1 described herein. Here, all conductors of the lens 1 (particularly the first and the second electrode 171, 172) other then said coil 111 do not form a closed loop.

Particularly, the first and the second electrode 171, 172 as well as the membrane assembly 71 may comprise an open annular shape or form an open loop as shown in FIGS. 21 and 22. Particularly, the first and the second electrodes 171, 172 can form an open loop of less than 360° (or of almost 360°) and are configured to not let electric current flow in a closed loop.

Furthermore, regarding FIGS. 21 and 22, the lens 1 can comprises an installation space 191 accommodating at least one electronic component of the lens 1 (or all electronic components other than the coil 111) such as the processing unit 190, which installation space 191 is arranged between opposing ends E of the membrane assembly 71 forming an open loop or open annular shape (e.g. an open conical frustum shape or an open spherical segment).

Particularly, as shown in FIG. 21 the coil 111 for charging/powering the lens 1 can extend around the lens volume 41 and may be arranged between the membrane assembly 71 and the lens volume 41. Alternatively, as shown in FIG. 22 the coil 111 may also extend further outside than the membrane assembly 71 along a periphery of the lens 1.

Furthermore, FIG. 20 illustrates a method for producing a membrane assembly 71 having the shape of a conical frustum or of a spherical segment, which membrane assembly can be used for an electro-osmotic pump (70 according to the present invention. Particularly, the method comprises the steps of:
providing a flat membrane assembly sheet 71′ (see dashed circle in FIG. 20) comprising a porous membrane 173 having a top (of first) surface 173t and a bottom (or second) surface 173b that faces away from the top surface 173t, wherein an electrode layer 171 (first electrode) is connected to the top surface 173t, and wherein an electrode layer 172 (second electrode) is connected to the bottom surface 173b,
separating a curved portion 71 of the flat membrane assembly sheet 71′ from the flat membrane assembly sheet 71′ to obtain a curved membrane assembly 71 having opposing ends E, and
bonding said opposing ends E to one another by a liquid-tight connection C to form the membrane assembly 71 into a conical frustum shape.

Optionally, the conical frustum shaped membrane assembly 71 can further be formed into a spherical segment, which is shown on the right hand side of FIG. 20.

While there are shown and described presently preferred embodiments of the invention, it is to be distinctly understood that the invention is not limited thereto but may be otherwise variously embodied and practiced within the scope of the following claims.

1. A lens for vision correction, wherein the lens comprises:
a transparent base element having a back side, and a front side facing away from the back side,
a transparent and elastically expandable membrane connected to said base element, wherein said membrane comprises a back side that faces said front side of the base element,
a lens shaping member so that the lens shaping member defines an area of the membrane having an adjustable curvature, and
wherein the lens comprises a lens volume adjacent said area, and wherein the lens comprises a reservoir volume arranged in a peripheral region of the lens, wherein a transparent liquid is arranged in the lens volume and in the reservoir volume, and
at least one electro-osmotic pump configured to transfer transparent liquid from the reservoir volume to the lens volume or vice versa such that the curvature of said area of the membrane changes and therewith the focal length of the lens.

2. Lens according to claim 1, characterized in that the at least one electro-osmotic pump comprises a membrane assembly,
the membrane assembly comprising a porous membrane, a first electrode, and a second electrode, wherein the porous membrane is arranged between said electrodes, and/or wherein said electrodes are connected to the porous membrane,
wherein said membrane assembly separates a first region of the reservoir volume from a second region of the reservoir volume.

3. (canceled)

4. Lens according to claim 2, characterized in that the lens volume and the first and the second region of the reservoir volume are filled with said transparent liquid, wherein the porous membrane is in flow connection with the lens volume via the second region of the reservoir volume, and wherein in order to transfer said liquid from the reservoir volume to the lens volume, the at least one electro-osmotic pump is configured to pump liquid from the first region of the reservoir volume into the second region of the reservoir volume, and/or wherein in order to transfer said liquid from the lens volume to the reservoir volume, the at least one electro-osmotic pump is configured to pump liquid from the second region of the reservoir volume into the first region of the reservoir volume.

5. Lens according to claim 2, characterized in that the lens comprises an actuator membrane which separates the reservoir volume from a pump volume, wherein the membrane assembly separates the pump volume into a first region and a second region, wherein the second region of the pump volume is arranged between the membrane assembly and the actuator membrane.

6.-8. (canceled)

9. Lens according to claim 2, characterized in that
the lens further comprises an inner annular structure and an outer annular structure, wherein the membrane assembly is connected to the outer and the inner annular structure, and
the lens shaping member is formed by the inner annular structure.

10.-12. (canceled)

13. The lens according to claim 9, characterized in that the inner annular structure is bonded to the front side of the base element and to the back side of the membrane.

14.-16. (canceled)

17. The lens according to claim 2, characterized in that the membrane assembly comprises one of: a curved shape, an annular shape, the shape of a spherical segment, the shape of a conical frustum.

18. (canceled)

19. The lens according to claim 2, characterized in that the membrane assembly comprises an undulated shape.

20. (canceled)

21. (canceled)

22. The lens according to claim 2, characterized in that the membrane assembly comprises a plurality of curved portions, wherein each curved portion connects two adjacent sections of the membrane assembly to one another such that the membrane assembly comprises a plurality of sections arranged on top of one another in a direction (D′) normal to the front side of the base element or parallel to an optical axis (A) of the lens.

23. (canceled)

24. (canceled)

25. The lens according to claim 2, characterized in that the membrane assembly forms a spiral extending around an optical axis (A) of the lens.

26. (canceled)

27. (canceled)

28. The lens according to claim 25, characterized in that the membrane assembly is folded onto itself to form a folded structure such that two sections of the second porous layer contact each other and extend side by side, and wherein said folded structure is formed into said spiral.

29.-33. (canceled)

34. The lens according to claim 1, characterized in that the lens shaping member separates the reservoir volume from the lens volume.

35. (canceled)

36. (canceled)

37. The lens according to claim 2, characterized in that the membrane assembly covers less than 50%, preferably less than 10%, of the front side of the base element.

38. The lens according to claim 25, characterized in that the at least one electro-osmotic membrane is configured to generate a flow (F) of the liquid that is directed along the front side of the base element.

39. (canceled)

40. (canceled)

41. Lens according to claim 25, characterized in that the reservoir volume is connected to the lens volume via at least one channel or via a plurality of channels, wherein the at least one channel or said plurality of channels is at least one of: at least partially formed into the lens shaping member and/or into the base element; formed into the lens shaping member; arranged between a portion of the lens shaping member and a portion of the base element is configured to measure a pressure of the liquid in the lens volume for a predefined time interval allowing liquid to flow back from the reservoir volume into the lens volume wherein the lens is configured to measure the streaming potential within the respective time interval, and wherein the lens is configured to compare the measured streaming potential to an expected value of the streaming potential corresponding to the desired focal length, wherein the lens is configured to adjust said voltage so that the respective measured streaming potential approaches the expected value of the streaming potential.

42.-66. (canceled)

67. Method for producing a membrane assembly for an electro-osmotic pump, comprising the steps of:
providing a flat membrane assembly sheet comprising a porous membrane having a top surface and a bottom surface that faces away from the top surface, wherein an electrode layer is arranged on the top surface, and wherein an electrode layer is arranged on the bottom surface,
separating a curved portion of the flat membrane assembly sheet from the flat membrane assembly sheet to obtain a curved membrane assembly having opposing ends (E),
bonding said opposing ends (E) to one another by a liquid-tight connection (C) to form the membrane assembly into a conical frustum shape, and wherein the conical frustum shaped membrane assembly is formed into a spherical segment.

68. (canceled)
